(19) United States
(12) Patent Application Publication
(10) Pub. No.: US 2026/0046899 A1
(43) Pub. Date: Feb. 12, 2026

(54) MEASURING PERFORMANCE OF END-TO-END COMMUNICATION PATHS IN UE-TO-UE RELAY

(71) Applicant: QUALCOMM INCORPORATED, San Diego, CA (US)

(72) Inventors: Jianhua Liu, Beijing (CN); Karthika Paladugu, Hyderabad (IN); Hong Cheng, Basking Ridge, NJ (US); Qing Li, Princeton Junction, NJ (US)

(21) Appl. No.: 19/101,890

(22) PCT Filed: Sep. 30, 2022
(86) PCT No.: PCT/CN2022/123267

§ 371 Date: Feb. 6, 2025

(51) Int. Cl. H04W 72/25; H04L 47/283; H04W 88/04

(52) U.S. Cl. CPC H04W 72/25; H04L 47/283; H04W 88/04

(57) ABSTRACT

Methods, systems, and devices for wireless communications are described. A first user equipment (UE) may establish a first end-to-end (E2E) link between the first UE and a second UE. The first UE may transmit a message. The first UE may receive a response and calculate a round-trip time (RTT) associated with the link based on the message and the response. The first UE and the second UE may perform procedures associated with measuring packet loss. The second UE may receive one or more messages of a set of messages and determine a quantity of messages lost. The first UE, the second UE, or a third UE configured to relay communications may calculate a metric based on the messages lost, the quantity of total messages, one or more status reports, or any combination thereof.

### CROSS REFERENCE

This application is a 371 National Stage of PCT Application No. PCT/CN2022/123267, filed on Sep. 30, 2022, entitled “MEASURING PERFORMANCE OF END-TO-END COMMUNICATION PATHS IN UE-TO-UE RELAY”, and assigned to the assignee hereof. The disclosure of the prior Application is considered part of and is incorporated by reference into this Patent Application.

### FIELD OF TECHNOLOGY

The following relates to wireless communications, including measuring performance of end-to-end (E2E) communication paths in user equipment (UE) to UE (U2U) relay.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support measuring performance of end-to-end (E2E) communication paths in user equipment (UE) to UE (U2U) relay. The described techniques provide for procedures to measure performance of E2E communication paths, which may result in reduced latency and reduced quantity of failed transmissions. For example, a first UE may establish a first E2E link between the first UE and a second UE. The first UE may transmit a message including a protocol data unit (PDU) and a request service data unit (SDU) used for round-trip time (RTT) calculations. The first UE may receive a response SDU from the second UE and calculate an RTT associated with the E2E link based on a difference between a timestamp associated with receiving the response SDU and a timestamp associated with transmitting the request SDU.

In some implementations, the first UE and the second UE may perform procedures associated with measuring packet loss. For example, the first UE may be a source UE and the second UE may be a destination UE. The destination UE may receive one or more messages of a batch (e.g., a set, multiple) of messages and determine a quantity of messages lost (e.g., unsuccessfully received) based on a sequence number indicating a total quantity of messages for the batch of messages. The destination UE may calculate a metric (e.g., a packet lost ratio (PLR)) based on the messages lost and the quantity of total messages (e.g., messages lost and messages received). In some cases, the source UE may calculate the metric based on one or more status reports from the destination UE indicating the quantity of messages lost. In some cases, a third UE configured to relay communications between the first UE and the second UE may also perform procedures associated with measuring packet loss of the E2E link.

A method for wireless communication at a first UE is described. The method may include establishing an E2E link with a second UE for communicating traffic, the E2E link including a set of multiple paths, each of the set of multiple paths including one or more sidelink communication links, communicating, with the second UE via a first path of the set of multiple paths of the E2E link, a first message associated with measuring a RTT for the first path of the E2E link, communicating a second message via the first path of the E2E link based on communicating the first message, and calculating the RTT associated with the first path of the E2E link based on communicating the first message and the second message.

An apparatus for wireless communication at a first UE is described. The apparatus may include a processor, memory coupled with the processor, and instructions stored in the memory. The instructions may be executable by the processor to cause the apparatus to establish an E2E link with a second UE for communicating traffic, the E2E link including a set of multiple paths, each of the set of multiple paths including one or more sidelink communication links, communicating, with the second UE via a first path of the set of multiple paths of the E2E link, a first message associated with measuring a RTT for the first path of the E2E link, communicate a second message via the first path of the E2E link based on communicating the first message, and calculate the RTT associated with the first path of the E2E link based on communicating the first message and the second message.

Another apparatus for wireless communication at a first UE is described. The apparatus may include means for establishing an E2E link with a second UE for communicating traffic, the E2E link including a set of multiple paths, each of the set of multiple paths including one or more sidelink communication links, means for communicating, with the second UE via a first path of the set of multiple paths of the E2E link, a first message associated with measuring a RTT for the first path of the E2E link, means for communicating a second message via the first path of the E2E link based on communicating the first message, and means for calculating the RTT associated with the first path of the E2E link based on communicating the first message and the second message.

A non-transitory computer-readable medium storing code for wireless communication at a first UE is described. The code may include instructions executable by a processor to establish an E2E link with a second UE for communicating traffic, the E2E link including a set of multiple paths, each of the set of multiple paths including one or more sidelink communication links, communicating, with the second UE via a first path of the set of multiple paths of the E2E link, a first message associated with measuring a RTT for the first path of the E2E link, communicate a second message via the first path of the E2E link based on communicating the first message, and calculate the RTT associated with the first path of the E2E link based on communicating the first message and the second message.

Some examples of the method, apparatuses, and non-transitory computer-readable medium described herein may further include operations, features, means, or instructions for communicating with the second UE based on calculating the RTT, where the first message and the second message may be associated with a Packet Data Convergence Protocol (PDCP) layer of a communication protocol stack.

In some examples of the method, apparatuses, and non-transitory computer-readable medium described herein, the first message may be a first PDU of a PDCP layer that includes a first header configured for measuring RTTs, a SDU associated with a RTT request, or both and the second message may be a second PDU of the PDCP layer that includes a second header configured for measuring RTTs, a SDU associated with a RTT response, or both.

Some examples of the method, apparatuses, and non-transitory computer-readable medium described herein may further include operations, features, means, or instructions for storing a first timestamp associated with transmitting the first message, where calculating the RTT associated with the E2E link includes and calculating a difference between a second timestamp associated with receiving the second message and the first timestamp.

Some examples of the method, apparatuses, and non-transitory computer-readable medium described herein may further include operations, features, means, or instructions for receiving, from a network entity, a message including a configuration, where the second message may be associated with the first message based on the configuration.

Some examples of the method, apparatuses, and non-transitory computer-readable medium described herein may further include operations, features, means, or instructions for receiving, from a network entity, a message including a configuration indicating a window duration associated with communicating the second message, the second message including a status report.

In some examples of the method, apparatuses, and non-transitory computer-readable medium described herein, the configuration indicates to transmit a respective status report for one or more round-trip request messages received during the window duration, the respective status report including a sequence number, a count value, or both, associated with the one or more round-trip request messages and the one or more round-trip request messages includes the first message.

Some examples of the method, apparatuses, and non-transitory computer-readable medium described herein may further include operations, features, means, or instructions for calculating a sequence number count based on an index value, the window duration, and an initial sequence number associated with a first round-trip request message, where the status report includes the sequence number count.

In some examples of the method, apparatuses, and non-transitory computer-readable medium described herein, communicating the second message may include operations, features, means, or instructions for transmitting the second message in a next available transmission time resource subsequent to receiving the first message.

A method for wireless communication at a first UE is described. The method may include establishing an E2E link with a second UE for communicating traffic, the E2E link including a set of multiple paths, each of the set of multiple paths including one or more sidelink communication links, receiving, via a first path of the E2E link, one or more messages during a window duration, and calculating a metric associated with packet loss for the first path based on receiving the one or more messages during the window duration and a quantity of total messages of a sequence of messages associated with the one or more messages.

An apparatus for wireless communication at a first UE is described. The apparatus may include a processor, memory coupled with the processor, and instructions stored in the memory. The instructions may be executable by the processor to cause the apparatus to establish an E2E link with a second UE for communicating traffic, the E2E link including a set of multiple paths, each of the set of multiple paths including one or more sidelink communication links, receive, via a first path of the E2E link, one or more messages during a window duration, and calculate a metric associated with packet loss for the first path based on receiving the one or more messages during the window duration and a quantity of total messages of a sequence of messages associated with the one or more messages.

Another apparatus for wireless communication at a first UE is described. The apparatus may include means for establishing an E2E link with a second UE for communicating traffic, the E2E link including a set of multiple paths, each of the set of multiple paths including one or more sidelink communication links, means for receiving, via a first path of the E2E link, one or more messages during a window duration, and means for calculating a metric associated with packet loss for the first path based on receiving the one or more messages during the window duration and a quantity of total messages of a sequence of messages associated with the one or more messages.

A non-transitory computer-readable medium storing code for wireless communication at a first UE is described. The code may include instructions executable by a processor to establish an E2E link with a second UE for communicating traffic, the E2E link including a set of multiple paths, each of the set of multiple paths including one or more sidelink communication links, receive, via a first path of the E2E link, one or more messages during a window duration, and calculate a metric associated with packet loss for the first path based on receiving the one or more messages during the window duration and a quantity of total messages of a sequence of messages associated with the one or more messages.

In some examples of the method, apparatuses, and non-transitory computer-readable medium described herein, the one or more messages may be associated with a PDCP layer of a communication protocol stack.

Some examples of the method, apparatuses, and non-transitory computer-readable medium described herein may further include operations, features, means, or instructions for transmitting, to the second UE, the calculated metric associated with packet loss via a radio resource control layer of the communication protocol stack, the PDCP layer of the communication protocol stack, or both.

In some examples of the method, apparatuses, and non-transitory computer-readable medium described herein, calculating the metric associated with packet loss may include operations, features, means, or instructions for determining a quantity of unsuccessful messages associated with the one or more messages during the window duration based on one or more sequence numbers, one or more count values, or both, associated with the one or more messages, calculating the quantity of total messages based on a combination of the quantity of unsuccessful messages and a quantity of successful messages associated with the one or more messages during the window duration, and calculating the metric based on a separation between the quantity of unsuccessful messages and the quantity of total messages.

In some examples of the method, apparatuses, and non-transitory computer-readable medium described herein, calculating the metric associated with packet loss may include operations, features, means, or instructions for calculating a respective metric for each radio bearer of a set of radio bearers based on respective sets of messages for each radio bearer of the set of radio bearers and a respective quantity of total messages for each radio bearer of the set of radio bearers.

Some examples of the method, apparatuses, and non-transitory computer-readable medium described herein may further include operations, features, means, or instructions for reordering the one or more messages based on a respective sequence number for each of the one or more messages, where calculating the metric associated with packet loss may be further based on reordering the one or more messages.

Some examples of the method, apparatuses, and non-transitory computer-readable medium described herein may further include operations, features, means, or instructions for receiving, from a network entity, the second UE, or both, a configuration indicating the window duration, where calculating the metric associated with packet loss may be further based on the configuration.

In some examples of the method, apparatuses, and non-transitory computer-readable medium described herein, the one or more messages include SDUs of the PDCP layer.

Some examples of the method, apparatuses, and non-transitory computer-readable medium described herein may further include operations, features, means, or instructions for transmitting, to the second UE, a set of multiple messages associated with packet loss, where receiving the one or more messages may be based on transmitting the set of multiple messages, the set of multiple messages including SDUs of the PDCP layer.

In some examples of the method, apparatuses, and non-transitory computer-readable medium described herein, the one or more messages include respective status reports configured by a network entity for each SDU of the set of multiple messages during a second window duration included in the window duration, each SDU of the set of multiple messages during a first periodic window duration including the window duration, or each successful SDU of the set of multiple messages during a second periodic window duration including the window duration, the respective status reports indicating an unsuccessful message or a successful message.

Some examples of the method, apparatuses, and non-transitory computer-readable medium described herein may further include operations, features, means, or instructions for transmitting, to the second UE, a first message indicating to start a path loss measurement procedure based on establishing the E2E link and a second message indicating to stop the path loss measurement procedure based on receiving the one or more messages, where the window duration may be associated with the indication to start and the indication to stop.

In some examples of the method, apparatuses, and non-transitory computer-readable medium described herein, calculating the metric associated with packet loss may include operations, features, means, or instructions for calculating a respective metric associated with each path of the set of multiple paths based on a respective quantity of unsuccessful messages associated with each path and a respective quantity of successful messages associated with each path, the respective quantity of unsuccessful messages, the respective quantity of successful messages, or both, indicated by the one or more messages.

A method for wireless communication at a first UE is described. The method may include establishing a first E2E link between the first UE and a second UE, where the first link includes a second link between the first UE and a third UE that is configured to relay communications between the first UE and the second UE, transmitting, to the second UE via the second link, one or more messages during a window duration, determining a first quantity of unsuccessful messages associated with the second link, a first quantity of successful messages associated with the second link, or both, based on transmitting the one or more messages, and calculating a metric associated with packet loss based on transmitting the one or more messages during the window duration and a quantity of total messages associated with the one or more messages.

An apparatus for wireless communication at a first UE is described. The apparatus may include a processor, memory coupled with the processor, and instructions stored in the memory. The instructions may be executable by the processor to cause the apparatus to establish a first E2E link between the first UE and a second UE, where the first link includes a second link between the first UE and a third UE that is configured to relay communications between the first UE and the second UE, transmit, to the second UE via the second link, one or more messages during a window duration, determine a first quantity of unsuccessful messages associated with the second link, a first quantity of successful messages associated with the second link, or both, based on transmitting the one or more messages, and calculate a metric associated with packet loss based on transmitting the one or more messages during the window duration and a quantity of total messages associated with the one or more messages.

Another apparatus for wireless communication at a first UE is described. The apparatus may include means for establishing a first E2E link between the first UE and a second UE, where the first link includes a second link between the first UE and a third UE that is configured to relay communications between the first UE and the second UE, means for transmitting, to the second UE via the second link, one or more messages during a window duration, means for determining a first quantity of unsuccessful messages associated with the second link, a first quantity of successful messages associated with the second link, or both, based on transmitting the one or more messages, and means for calculating a metric associated with packet loss based on transmitting the one or more messages during the window duration and a quantity of total messages associated with the one or more messages.

A non-transitory computer-readable medium storing code for wireless communication at a first UE is described. The code may include instructions executable by a processor to establish a first E2E link between the first UE and a second UE, where the first link includes a second link between the first UE and a third UE that is configured to relay communications between the first UE and the second UE, transmit, to the second UE via the second link, one or more messages during a window duration, determine a first quantity of unsuccessful messages associated with the second link, a first quantity of successful messages associated with the second link, or both, based on transmitting the one or more messages, and calculate a metric associated with packet loss based on transmitting the one or more messages during the window duration and a quantity of total messages associated with the one or more messages.

Some examples of the method, apparatuses, and non-transitory computer-readable medium described herein may further include operations, features, means, or instructions for receiving, from the third UE via a radio link control layer, a message indicating a second quantity of unsuccessful messages associated with a third link between the third UE and the second UE, a second quantity of successful messages associated with the third link, or both, where determining the first quantity of unsuccessful messages or the first quantity of successful messages may be further based on a threshold associated with retransmission being satisfied.

In some examples of the method, apparatuses, and non-transitory computer-readable medium described herein, calculating the metric may include operations, features, means, or instructions for calculating the metric based on a combination of the first quantity of unsuccessful messages and the second quantity of unsuccessful messages, where the metric may be associated with the first link and calculating the metric based on a combination of the first quantity of successful messages and the second quantity of successful messages, where the metric may be associated with the first link.

In some examples of the method, apparatuses, and non-transitory computer-readable medium described herein, determining the first quantity of unsuccessful messages or the first quantity of successful messages is further based at least in part on one or more sequence numbers associated with the one or more messages, where the method, apparatuses, and non-transitory computer-readable medium may include further operations, features, means, or instructions for calculating the quantity of total messages based on a combination of the first quantity of unsuccessful messages and the first quantity of successful messages associated with the one or more messages and calculating a second metric associated with successfully received messages based on a separation between the first quantity of successful messages and the quantity of total messages.

Some examples of the method, apparatuses, and non-transitory computer-readable medium described herein may further include operations, features, means, or instructions for receiving, from the second UE, a message indicating a third metric associated with successfully received messages on a third link between the third UE and the second UE, where calculating the metric associated with packet loss may include operations, features, means, or instructions for calculating a first difference between a first value and the second metric and a second difference between a second value and the third metric and calculating a third difference between a third value and a product of the first difference and the second difference.

Some examples of the method, apparatuses, and non-transitory computer-readable medium described herein may further include operations, features, means, or instructions for receiving, from the second UE, a message indicating a second metric associated with successfully received messages on the second link and a third metric associated with successfully received messages on a third link between the third UE and the second UE, where the second metric includes the first quantity of successful messages and calculating the metric associated with packet loss includes: calculating a first difference between a first value and the second metric and a second difference between a second value and the third metric and calculating a third difference between a third value and a product of the first difference and the second difference.

In some examples of the method, apparatuses, and non-transitory computer-readable medium described herein, the one or more messages may be associated with a radio link control layer of a communication protocol stack.

A method for wireless communication at a third UE is described. The method may include establishing a second link between the third UE and a first UE and a third link between the third UE and a second UE, where the second link and the third link are included in a first E2E link between the first UE and the second UE and the third UE is configured to relay communications between the first UE and the second UE, receiving, from the first UE via the second link, a first set of one or more messages during a first window duration, transmitting, to the second UE via the third link, a second set of one or more messages during a second window duration, and transmitting, to the first UE via the second link, a quantity associated with packet loss based on receiving the first set and transmitting the second set.

An apparatus for wireless communication at a third UE is described. The apparatus may include a processor, memory coupled with the processor, and instructions stored in the memory. The instructions may be executable by the processor to cause the apparatus to establish a second link between the third UE and a first UE and a third link between the third UE and a second UE, where the second link and the third link are included in a first E2E link between the first UE and the second UE and the third UE is configured to relay communications between the first UE and the second UE, receive, from the first UE via the second link, a first set of one or more messages during a first window duration, transmit, to the second UE via the third link, a second set of one or more messages during a second window duration, and transmit, to the first UE via the second link, a quantity associated with packet loss based on receiving the first set and transmitting the second set.

Another apparatus for wireless communication at a third UE is described. The apparatus may include means for establishing a second link between the third UE and a first UE and a third link between the third UE and a second UE, where the second link and the third link are included in a first E2E link between the first UE and the second UE and the third UE is configured to relay communications between the first UE and the second UE, means for receiving, from the first UE via the second link, a first set of one or more messages during a first window duration, means for transmitting, to the second UE via the third link, a second set of one or more messages during a second window duration, and means for transmitting, to the first UE via the second link, a quantity associated with packet loss based on receiving the first set and transmitting the second set.

A non-transitory computer-readable medium storing code for wireless communication at a third UE is described. The code may include instructions executable by a processor to establish a second link between the third UE and a first UE and a third link between the third UE and a second UE, where the second link and the third link are included in a first E2E link between the first UE and the second UE and the third UE is configured to relay communications between the first UE and the second UE, receive, from the first UE via the second link, a first set of one or more messages during a first window duration, transmit, to the second UE via the third link, a second set of one or more messages during a second window duration, and transmit, to the first UE via the second link, a quantity associated with packet loss based on receiving the first set and transmitting the second set.

Some examples of the method, apparatuses, and non-transitory computer-readable medium described herein may further include operations, features, means, or instructions for receiving, from the second UE via the third link, a first message indicating a first quantity of successful messages associated with the third link and the second set, a first quantity of unsuccessful messages associated with the third link and the second set, or both, determining a second quantity of successful messages associated with the second link and the first set, a second quantity of unsuccessful messages associated with the second link and the first set, or both, based on a threshold associated with retransmission being satisfied, and calculating the quantity associated with packet loss based on a combination between the first quantity of successful messages and the second quantity of successful messages or a combination between the first quantity of unsuccessful messages and the second quantity of unsuccessful messages.

### BRIEF DESCRIPTION OF THE DRAWINGS

FIGS. 1 through 3B illustrate examples of wireless communications systems that support measuring performance of end-to-end (E2E) communication paths in user equipment (UE) to UE (U2U) relay in accordance with one or more aspects of the present disclosure.

FIG. 4 through 6 illustrate examples of process flows that support measuring performance of E2E communication paths in U2U relay in accordance with one or more aspects of the present disclosure.

FIGS. 7 and 8 illustrate block diagrams of devices that support measuring performance of E2E communication paths in U2U relay in accordance with one or more aspects of the present disclosure.

FIG. 9 illustrates a block diagram of a communications manager that supports measuring performance of E2E communication paths in U2U relay in accordance with one or more aspects of the present disclosure.

FIG. 10 illustrates a diagram of a system including a device that supports measuring performance of E2E communication paths in U2U relay in accordance with one or more aspects of the present disclosure.

FIGS. 11 through 14 illustrate flowcharts showing methods that support measuring performance of E2E communication paths in U2U relay in accordance with one or more aspects of the present disclosure.

### DETAILED DESCRIPTION

Some wireless communications systems may support sidelink communications. The sidelink communication may include a first user equipment (UE) (e.g., a source UE), a second UE (e.g., a destination UE), and a third UE (e.g., a relay UE) configured to relay communications between the first UE and the second UE. The communication link between the first UE and the second UE may be an end-to-end (E2E) link that includes a first link (e.g., a first hop) between the first UE and the third UE and a second link (e.g., a second hop) between the third UE and the second UE. Some wireless communication systems may allow for multiple configured multi-path connections in which the third UE may be one of several configured relay UEs for relaying communications between the first UE and the second UE. In some cases, the first UE may utilize a first relay UE using a first communication path for first traffic and a second relay UE using a second communication path for second traffic. However, some wireless communication systems may not provide a procedure for the first UE to measure performance on the various communication paths and determine which of the various relay UEs to use for respective traffic. To support measuring and selecting a communication path utilizing one of several candidate relay UEs, a measuring procedure may be defined.

The techniques described herein provide for procedures to measure performance of E2E communication paths, which may result in reduced latency and reduced quantity of failed transmissions. For example, a first UE may establish a first E2E link between the first UE and a second UE. The first UE may transmit a message including a protocol data unit (PDU) and a request service data unit (SDU) used for round-trip time (RTT) calculations. The first UE may receive a response SDU from the second UE and calculate an RTT associated with the E2E link based on a difference between a timestamp associated with receiving the response SDU and a timestamp associated with transmitting the request SDU.

In some implementations, the first UE and the second UE may perform procedures associated with measuring packet loss. For example, the first UE may be a source UE and the second UE may be a destination UE. The destination UE may receive one or more messages of a set (e.g., multiple) of messages and determine a quantity of messages lost (e.g., unsuccessfully received) based on a sequence number indicating a total quantity of messages for the set of messages. The destination UE may calculate a metric (e.g., a packet lost ratio (PLR)) based on the messages lost and the quantity of total messages (e.g., messages lost and messages received). In some cases, the source UE may calculate the metric based on one or more status reports from the destination UE indicating the quantity of messages lost. In some cases, a third UE configured to relay communications between the first UE and the second UE may also perform procedures associated with measuring packet loss of the E2E link.

Aspects of the disclosure are initially described in the context of wireless communications systems. Aspects of the disclosure are further described in the context of process flows. Aspects of the disclosure are further illustrated by and described with reference to apparatus diagrams, system diagrams, and flowcharts that relate to measuring performance of E2E communication paths in UE-to-UE (U2U) relay.

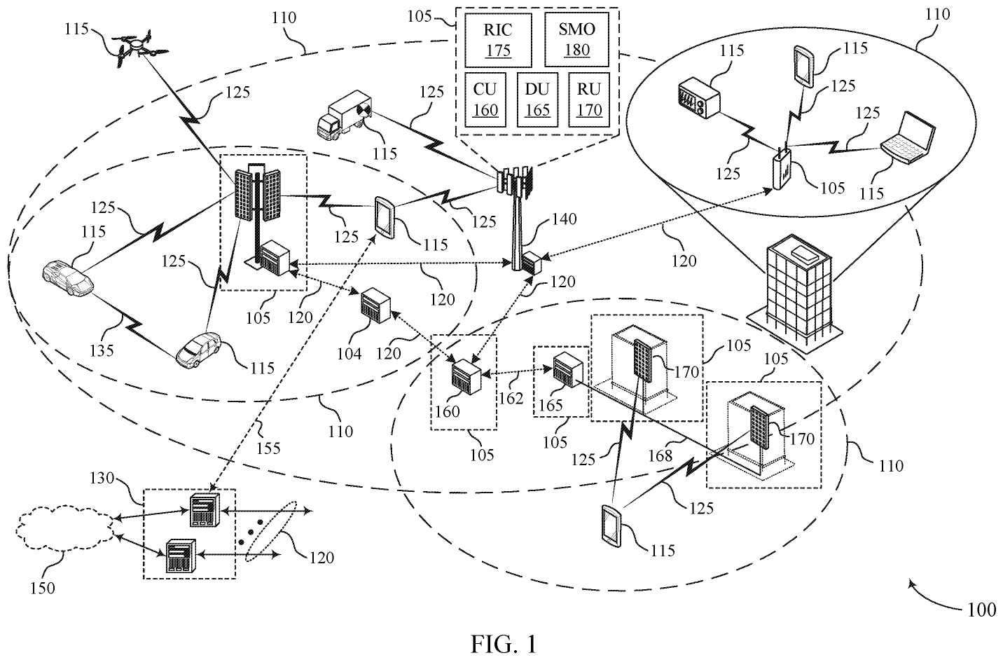

FIG. 1 illustrates an example of a wireless communications system 100 that supports measuring performance of E2E communication paths in U2U relay in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support measuring performance of E2E communication paths in U2U relay as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a third UE 115 may act as a relay for communications from a first UE 115 to a second UE 115. In such examples, the UE 115 that relays traffic between the first UE 115 and the second UE 115 (e.g., the third UE 115) may be referred to as a relay UE 115. The originator of the relayed traffic may be referred to as the source UE 115 (e.g., the first UE 115) and the destination of the relayed traffic may be referred to as the destination UE 115 (e.g., the second UE 115). If a single relay UE 115 is present between a source UE 115 and a destination UE 115, a single-hop relay may be present. If multiple relay UEs are present between the source UE 115 and the destination UE 115, a multi-hop relay may be present.

In some examples, a source UE 115 may perform a relay connection procedure (e.g., setup). For example, the source UE 115 may determine to perform a relay procedure associated with L3 relay or L2 relay. The source UE 115 may perform a relay discovery operation to discover potential (e.g., candidate) relay UEs. The source UE 115 may select the relay UE 115 and perform a route discovery operation. The source UE 115 may then communicate setup messages with the relay UE 115 (e.g., unicast link setup messages) to set up the first link and the relay UE 115 may communicate setup messages with a destination UE 115 to set up the second link. In some cases, for L3 relay, the source UE 115 may communicate messages to set up the first link that indicate a quality of service (QOS) associated with the L3 relay with the relay UE 115 and the relay UE 115 may communicate messages with the destination UE 115 indicating the QoS. In some cases, for L2 relay, the source UE 115 and the destination UE 115, via the relay UE 115, may communicate messages associated with an E2E link setup (e.g., E2E unicast link setup) and messages indicating QoS for the E2E link (e.g., E2E unicast link management for PC5 RLC channels). The source UE 115, the destination UE 115, and the relay UE 115 may be provided with discovery and relay security key material. The UEs 115 may perform sidelink communications (e.g., relay communications).

In some cases, the sidelink communications may include user and/or control data as part of a packet-based network operating according to a layered protocol stack. For example, a control plane and a user plane may include multiple layers as part of the protocol stack. In the user plane (e.g., L2 user plane), the protocol stack may include at least an internet protocol (IP) layer or other non-IP application or service layer, an SDAP layer, a PDCP layer, a sidelink relay adaptation protocol (SRAP) layer, an RLC layer, a MAC layer, and a PHY layer. In some cases, the IP/non-IP, SDAP, and PDCP layers may be associated with an E2E link and the SRAP, RLC, MAC, and PHY layers may be associated with a relay link. In the control plane (e.g., L2 control plane), the protocol stack may include at least a PC5-S layer, a PDCP layer, an SRAP layer, an RLC layer, a MAC layer, and a PHY layer. In some cases, the PC5-S and PDCP layers may be associated with an E2E link and the SRAP, RLC, MAC, and PHY layers may be associated with a relay link.

In some examples, remote UEs 115 may support dual path connection over two relays. For instance, a remote UE 115 may be connected with two relays using PC5 or non-3GPP radio access technology (RAT) access, where PC5 can be on a licensed or unlicensed frequency band. Alternatively, remote UEs 115 may support dual path connections over one relay and one direct path. In either case, each path may be used for E2E traffic aggregation or duplication and at least one E2E signaling radio bearer (SRB) or data radio bearer (DRB) may be applied. In a similar manner, remote UEs 115 may support multi-path connection over two or more relays. In some implementations, the remote UE 115 may determine which path should be used for traffic transmission.

In some cases, a remote UE 115 may indicate metrics such as packet loss, channel measurements, and the like, in a status report. For example, the status report may indicate whether a message (e.g., a PDCP SDU) is received or not received based on a count value or sequence number associated with the message. In some implementations, a receiving PDCP entity of the remote UE 115 may send the status report to a transmitting PDCP entity for both of unacknowledged and acknowledged modes of a DRB or a receiving RLC entity of the remote UE 115 may send the status report to a transmitting PDCP entity for the acknowledged mode of a DRM.

In some examples, a remote UE 115 may be in communication with a core network 130 (e.g., a UPF). The remote UE 115 may execute various performance measurements (e.g., RTT, PLR, and the like) associated with the communication channels (e.g., links) associated with communicating with the core network 130. For example, to calculate RTT, the remote UE 115 may utilize a performance measurement function (PMF) entity (e.g., in a PMF layer of a communication protocol stack) to send over request messages (e.g., user plane PMF echo request messages) to a PMF entity of the core network 130. The core network 130 may respond to each request with a response message (e.g., PMF echo response message) via the PMF entity. This communication procedure may be reversed such that the core network 130 may send the request message and the remote UE 115 may send the response message. To calculate PLR, the remote UE 115 may send a request message (e.g., PMF PLR count request message) requesting that the core network 130 begins to count a quantity of received uplink packets. Both the remote UE 115 and the core network 130 may count the quantity of uplink packets at either end of the communication link and determine the uplink PLR based on the local counting result and the reported counting result.

By executing the various performance measurements, the remote UE 115 and the core network 130 may continue communications and be able to perform various adjustments to the communication, which may result in, for example, fewer failed transmissions, reduced latency, reduced power consumption, and the like. However, some wireless communication systems may not provide a procedure for measuring performance of sidelink relay communication paths (e.g., U2U communication paths). To support measuring and selecting a communication path utilizing one of several candidate relay UEs, a measuring procedure may be defined.

The techniques described herein provide for procedures to measure performance of E2E communication paths, which may result in reduced latency and reduced quantity of failed transmissions. For example, a first UE may establish a first E2E link between the first UE and a second UE. The first UE may transmit a message including a PDU and a request SDU used for RTT calculations. The first UE may receive a response SDU from the second UE and calculate an RTT associated with the E2E link based on a difference between a timestamp associated with receiving the response SDU and a timestamp associated with transmitting the request SDU.

In some implementations, the first UE and the second UE may perform procedures associated with measuring packet loss. For example, the first UE may be a source UE and the second UE may be a destination UE. The destination UE may receive one or more messages of a set (e.g., multiple) of messages and determine a quantity of messages lost (e.g., unsuccessfully received) based on a sequence number indicating a total quantity of messages for the batch of messages. The destination UE may calculate a metric (e.g., a PLR) based on the messages lost and the quantity of total messages (e.g., messages lost and messages received). In some cases, the source UE may calculate the metric based on one or more status reports from the destination UE indicating the quantity of messages lost. In some cases, a third UE configured to relay communications between the first UE and the second UE may also perform procedures associated with measuring packet loss of the E2E link.

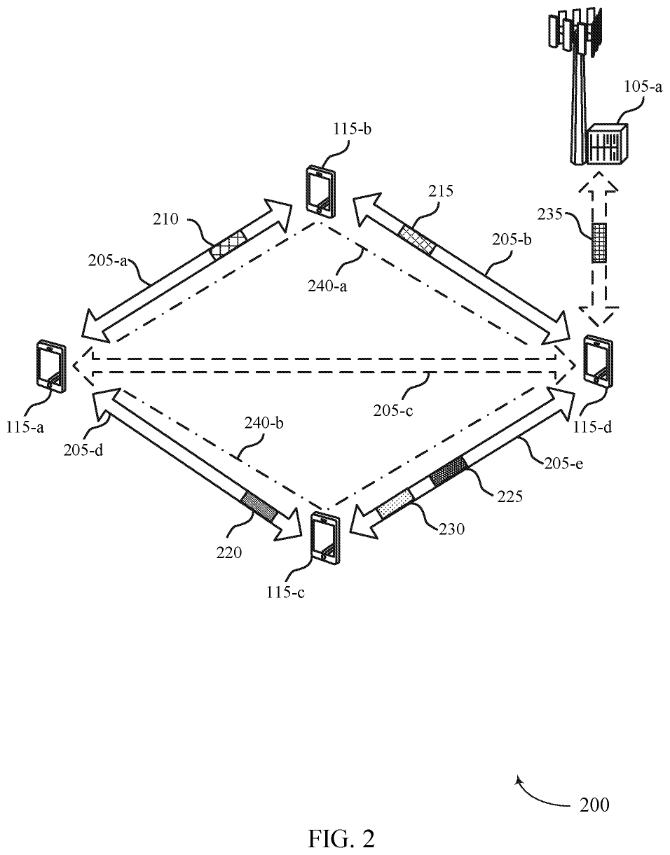

FIG. 2 illustrates an example of a wireless communications system 200 that supports measuring performance of E2E communication paths in U2U relay in accordance with one or more aspects of the present disclosure. In some examples, the wireless communications system 200 may implement aspects of the wireless communications system 100. For example, the wireless communications system 200 may include a UE 115-a, a UE 115-b, a UE 115-c, and a UE 115-d, as well as a network entity 105-a, which may be examples of a UE 115 and a network entity 105, as described herein with reference to FIG. 1. In some cases, the UE 115-a may represent an example of a source UE 115, the UEs 115-b and 115-c may represent relay UEs 115, and the UE 115-d may represent a destination UE 115.

The wireless communications system 200 may represent various communications paths (e.g., a multi-path connection) between the UE 115-a and the UE 115-d. For example, the UE 115-a may be directly connected with the UE 115-d via a link 205-c (e.g., a direct link), the UE 115-a may be indirectly connected with the UE 115-d via a path 240-a that includes a first link 205-a between the UE 115-a and the UE 115-b and a second link 205-b between the UE 115-b and the UE 115-d, or via a path 240-b that includes a third link 205-d between the UE 115-c and a fourth link 205-e between the UE 115-c and the UE 115-d, or any combination thereof. In some implementations, the UE 115-a may also be in communication with the network entity 105-a.

Some wireless communications systems may include performance measurement procedures for measuring a communication path between the UE 115-a and the network entity 105-a (e.g., a core network 130, a UPF). However, the wireless communications system may not provide a procedure for measuring performance of E2E communication paths in a U2U relay communication. For example, if the UE 115-a is configured for multi-path connection, the UE 115-a may be unable to obtain E2E performance information for each path, thus being unable to select an appropriate (e.g., better, more efficient) path to transmit traffic. The techniques described herein may support a method for the UE 115-a to dynamically monitor the E2E performance (e.g., RTT, PLR) on each path of a multi-path system, which may result in more accurate performance measurements (e.g., information as well as radio link quality).

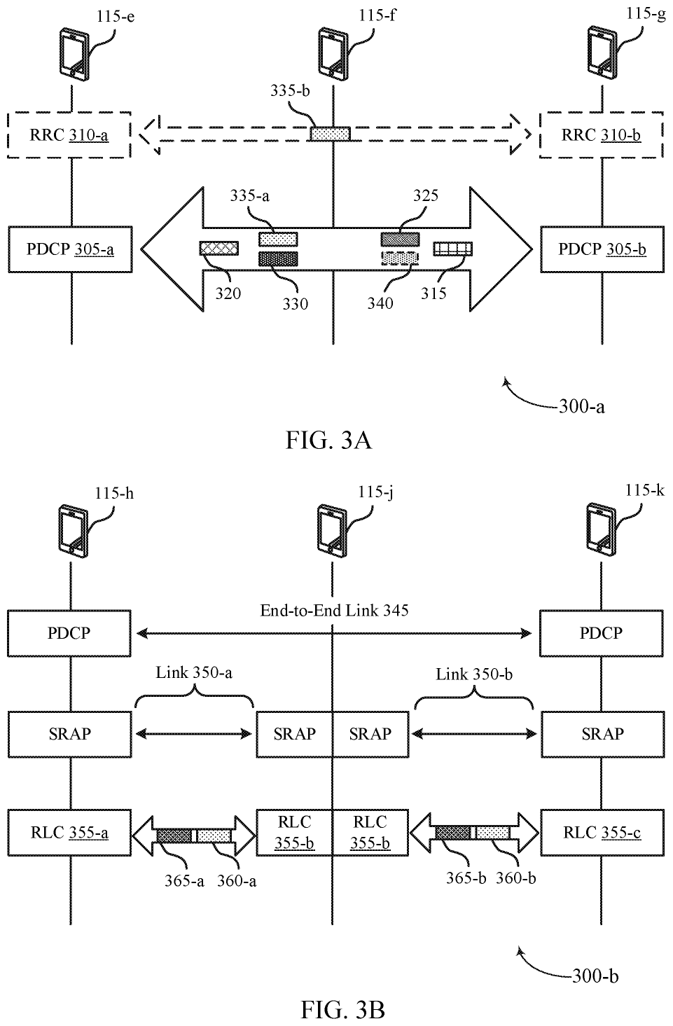

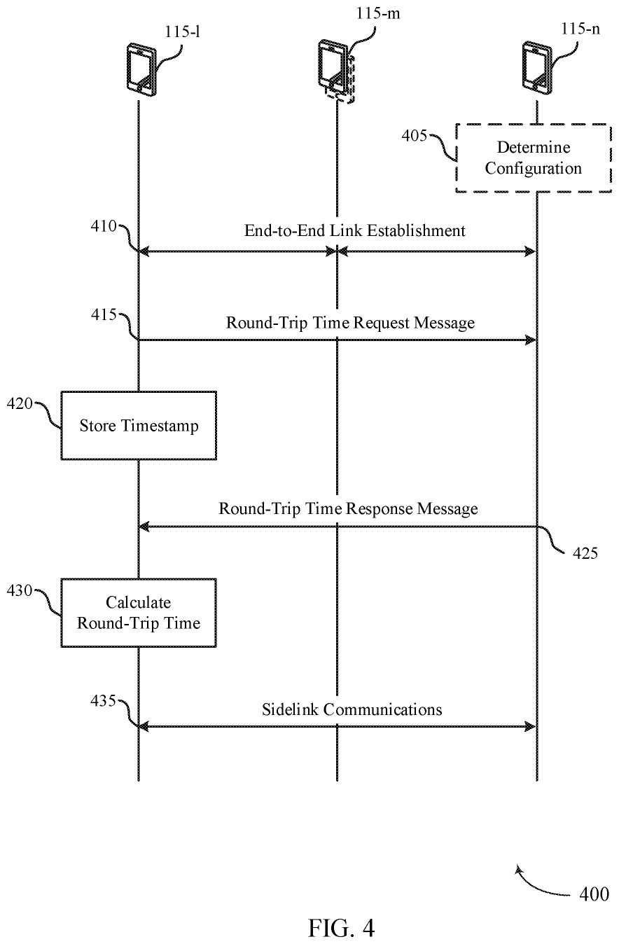

In some cases, the UE 115-a may transmit a message 210 associated with measuring an RTT for the path 240-a. For example, the message 210 may be a PDCP PDU (e.g., a new type of PDCP PDU) associated with RTT measurement packets. The PDU may carry a type of SDU associated with RTT measurement, such as a request SDU, as described herein with reference to FIGS. 3A and 4. As the PDCP layer (e.g., bearer associated with the PDCP PDU) is associated with an E2E link, the UE 115-b (e.g., a relay UE 115) may relay the message 210 to the UE 115-d via the link 205-b. The UE 115-d may receive the SDU request and transmit a message 215. In some cases, the message 215 may be a PDCP SDU response message, a status report, or another message indicating an RTT response. The UE 115-a may calculate the RTT associated with the path 240-a based on the response message 215.

Alternatively to a specific PDCP SDU request message, the UE 115-a may transmit multiple messages 210 and the UE 115-d may determine (e.g., select, choose) which, if any, of the messages 210 to transmit a response message 215, as described herein with reference to FIGS. 3A and 4. The UE 115-d may receive a configuration 235 (e.g., from the network entity 105-a, from another remote UE 115, from the UE 115-a) indicating which message 210 to respond to.

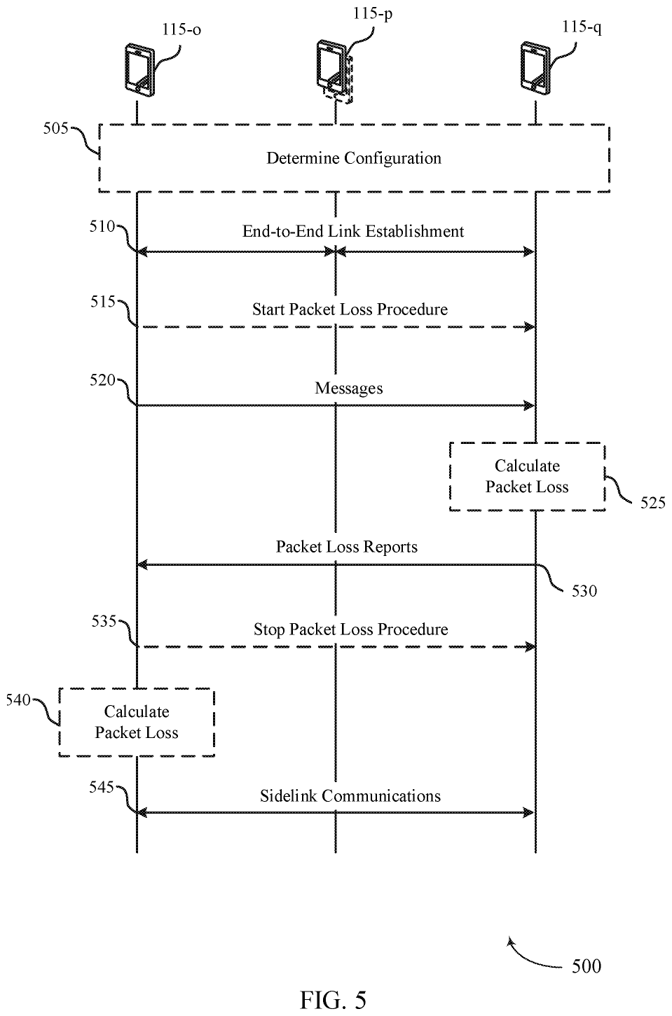

In some cases, the UE 115-a may transmit a message 220 associated with packet loss for the path 240-b. For example, the UE 115-a may transmit multiple messages 220 that may be PDCP SDUs associated with PLR measurement packets, as described herein with reference to FIGS. 3A and 5. As the PDCP layer (e.g., bearer associated with the PDCP SDUs) is associated with an E2E link, the UE 115-c (e.g., a relay UE 115) may relay the messages 220 to the UE 115-d via the link 205-e. The UE 115-d may receive the SDUs associated with PLR measurements and transmit a response, as described herein with reference to FIGS. 3A and 5. For instance, the UE 115-d may calculate the PLR for the path 240-b based on a quantity of received messages 220 and transmit a message 230 indicating the PLR. Alternatively, the response may be a status report message 225. The message 225 may indicate a quantity of successful or unsuccessful messages 220 that were received by the UE 115-d. The UE 115-a may calculate the PLR based on the indication of successful or unsuccessful PDCP SDUs.

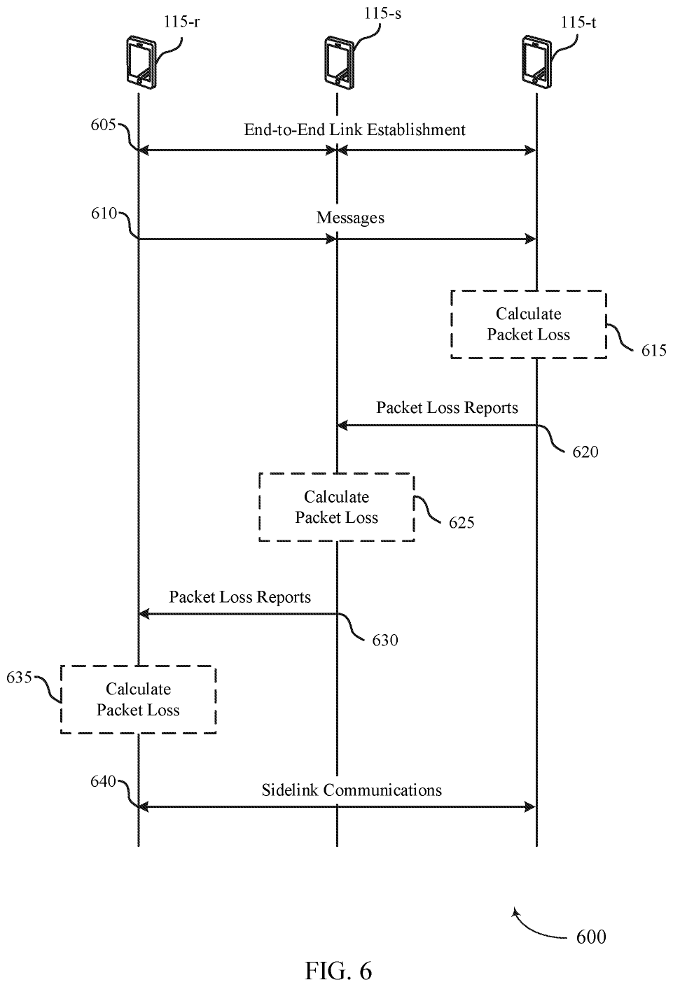

In some examples, the messages 220 associated with packet loss may include RLC packets, as described herein with reference to FIGS. 3B and 6. For example, the UE 115-a may transmit, to the UE 115-c, multiple RLC packets associated with PLR measurement. As the RLC layer is associated with relay links (e.g., the link 205-d, the link 205-e), the UE 115-c may determine a quantity of RLC packets received successfully, unsuccessfully, or both, on the link 205-d. The UE 115-c may transmit multiple RLC packets to the UE 115-d and the UE 115-d may determine a quantity of RLC packets received successfully, unsuccessfully, or both, on the link 205-e. In some cases, the UE 115-c may determine the quantity associated with the link 205-e (e.g., a packet rate) based on a retransmission threshold (e.g., if the retransmission threshold for a packet is satisfied then the packet is determined to be unsuccessful). Alternatively, the UE 115-d may transmit, to the UE 115-c, a first status report (e.g., message 225) indicating the quantity. The UE 115-c may transmit a second status report indicating the quantity associated with the link 205-e, the link 205-d, or both. The UE 115-a may calculate the E2E PLR of the path 240-b based on the quantities associated with the links 205-d and 205-e. In some cases, the UE 115-d or the UE 115-c may calculate the E2E PLR and transmit, to the UE 115-a, a message (e.g., message 230) indicating the calculated E2E PLR.

The examples described herein (while related to certain paths, remote UEs 115, and messages depicted in FIG. 2) may be associated with any quantity of communication paths 240, remote UEs 115, and messages. For example, the RTT messages may be communicated via the path 240-b, the link 205-c, or both. Additionally, or alternatively, the PLR messages may be communicated via the path 240-a, the link 205-c, or both.

FIGS. 3A and 3B illustrate examples of wireless communications systems 300-a and 300-b that support measuring performance of E2E communication paths in U2U relay in accordance with one or more aspects of the present disclosure. In some examples, the wireless communications systems 300-a and 300-b may implement aspects of the wireless communications systems 100 and 200, as described herein with reference to FIGS. 1 and 2. For example, the wireless communications systems 300-a may include a UE 115-e, a UE 115-f, and a UE 115-g, which may be examples of a UE 115, as described herein with reference to FIGS. 1 and 2. In some cases, the UE 115-e may represent an example of a source UE 115, the UE 115-f may represent a relay UE 115, and the UE 115-g may represent a destination UE 115. The wireless communications systems 300-b may include a UE 115-h, a UE 115-j, and a UE 115-k, which may be examples of a UE 115, as described herein with reference to FIGS. 1 and 2. In some cases, the UE 115-h may represent an example of a source UE 115, the UE 115-j may represent a relay UE 115, and the UE 115-k may represent a destination UE 115.

In some examples of FIG. 3A, the wireless communications system 300-a may support E2E RTT measurements via a PDCP layer. For example, the UE 115-e may include multiple entities (e.g., transmitting entities, receiving entities) associated with a communication protocol stack (e.g., an L2 relay protocol stack). The protocol stack may at least include a PDCP layer and, optionally, an RRC layer. In some cases, the UE 115-e may determine (e.g., select) which communication path (e.g., paths 240-a and 240-b) of a multi-path connection to utilize for transmitting traffic. In some implementations, the UE 115-e may perform an RTT measurement procedure for each path of the multi-path connection. For example, the UE 115-e may transmit, via a transmitting PDCP entity 305-a, a message 315. The message 315 may be a PDCP PDU carrying an SDU request message associated with RTT measurements. In some cases, the PDCP PDU may be a type of PDCP PDU associated with RTT measurements, and include a header to distinguish the type (e.g., a new type of PDCP PDU). The UE 115-e may store a first timestamp associated with transmitting the message 315.

In some cases, the UE 115-g may receive the message 315 via the PDCP entity 305-b. The UE 115-g may respond to the message 315 (e.g., the PDCP PDU carrying the request SDU) by transmitting a message 320. For example, the message 320 may be a PDCP PDU carrying an SDU response message (e.g., echo SDU) associated with RTT measurements. The UE 115-g may transmit the message 320 via the same communication path (e.g., path 240-a) that the UE 115-g received the message 315. In some cases, the UE 115-g may receive multiple messages 315. The message 320 may be associated with the latest (e.g., most recently received) message 315. The UE 115-e may receive the message 320 and determine a second timestamp associated with receiving the message 320. The UE 115-e may calculate an E2E RTT associated with the communication path via the UE 115-f according to a difference (e.g., a time difference) between the first timestamp and the second timestamp (e.g., the time sending the request SDU and the time receiving the echo SDU).

In some implementations, the message 320 may be a status report. For example, the UE 115-g may be configured (e.g., preconfigured, receive a configuration from a network entity 105, the UE 115-e, another remote UE 115) to transmit one or more status reports associated with the messages 315. For example, the configuration may indicate for which received PDCP SDU the status report (e.g., a response PDU, a status report PDCP PDU) should be sent. In some cases, the configuration may indicate a period (P) (e.g., a window duration) of received PDCP SDUs for which the UE 115-g should send respective messages 320. In some examples, the UE 115-g may determine which of the PDCP SDUs during the period to respond. The UE 115-g may include a sequence number, a count value, or both (e.g., SN (COUNT)), in the response PDU.

In some cases, the configuration may indicate which SDUs to respond to according to Equation 1:

$$SN ( COUNT ) = I * P + {SN}_{start} \qquad Equation 1$$

where I is an integer starting from zero (e.g., index value) that is incremented (e.g., increased by one) for each response, and SNₛₜₐᵣₜ is the first indicated PDCP SDU to respond to. In either configuration, the UE 115-g may transmit the message 320 (e.g., a response PDU) in a next available transmission time resource subsequent to receiving the respective message 315 (e.g., immediately after receiving the respective SDU) via the same path in which the respective message 315 was received. The UE 115-e may calculate the E2E RTT of the path according to a time difference between the time sending the PDCP PDU and the time receiving the status report for the PDCP PDU. Based on the calculation, the UE 115-e may transmit the traffic, via the UE 115-f (e.g., the selected communication path), to the UE 115-g. For example, the UE 115-e may calculate an E2E RTT associated with another relay UE 115 and determine that the E2E RTT associated with the UE 115-f is better (e.g., less than, includes less latency).

In some examples of FIG. 3A, the wireless communications system 300-a may support E2E PLR measurements via a PDCP layer. For example, the UE 115-e may determine which communication path of a multi-path connection to utilize for transmitting traffic. In some implementations, the UE 115-e may perform an E2E PLR measurement procedure for each path of the multi-path connection. For example, the UE 115-e may transmit, via the transmitting PDCP entity 305-a, a message 325. The message 325 may be representative of multiple SDUs associated with packet loss.

In some cases, the UE 115-g may calculate a metric associated with packet loss (e.g., PLR). For example, the PDCP 305-b may be configured (e.g., preconfigured, configured via a configuration message) with a window duration (T) for PLR calculation. During the window duration, the PDCP 305-b may calculate PLR according to Equation 2:

$$PLR = \frac{{N}_{loss}}{{N}_{loss} + {N}_{received}} \qquad Equation 2$$

where Nₗₒₛₛ is a quantity of missing SDUs during the window duration T and N_{received} is a quantity of successfully received SDUs during the window duration T. In some cases, the calculation may be performed per radio bearer (e.g., SRB, DRB), after re-ordering (e.g., ordering the messages 325 according to respective sequence numbers), or both. In some cases, the radio bearer may be a standalone bearer (e.g., a single configured path).

In some examples, the UE 115-g may transmit a message 335. For example, a receiving PDCP entity 305-b of the UE 115-g may send the calculation result (e.g., the PLR measurement, message 335-a) to a transmitting PDCP entity 305-a of the UE 115-e. The transmitting PDCP entity 305-a may forward the message 335-a to a receiving RRC entity 310-a of the UE 115-e. Alternatively, the receiving PDCP entity 305-b may forward the calculation result to a transmitting RRC entity 310-b of the UE 115-g, and the transmitting RRC entity 310-b may send a message 335-b (including the calculation result) to the receiving RRC entity 310-a.

Additionally, or alternatively, the UE 115-e may calculate the metric associated with packet loss based on one or more status reports 330. For example, the PDCP entity 305-b of the UE 115-g may be configured to send status reports 330 for the messages 325 (e.g., received SDUs), where the status reports 330 may indicate which SDUs are missing (e.g., unsuccessfully received), which SDUs are received correctly (e.g., successfully received), or both. In some cases, the configuration may indicate to send status reports 330 for each received SDU during a period P or a quantity M of received SDUs during the period P: the configuration may indicate to send status reports 330 for each SDU (e.g., both received and lost) during the period P or a quantity N of SDUs during the period P: the configuration may indicate to send status reports 330 for each SDU each window duration T or each SDU during duration T′ of each window duration T: or any combination thereof.

In some cases, the UE 115-g may send the status reports 330 according to one or more messages 340. For example, the UE 115-e may transmit, to the UE 115-g, a first message 340 indicating to start the path loss measurement procedure and a second message 340 indicating to stop the path loss measurement procedure. The PDCP entity 305-b may send status reports 330 for the SDUs received between the start and stop indications. In some cases, the window duration T may be associated with the start and stop indications (e.g., the indications may determine a beginning and an end of the window duration).

In some implementations, the UE 115-e may calculate PLR for each path of the multi-path connection based on the received status reports 330. For example, the PDCP entity 305-a may calculate PLR per path (e.g., path 240, PLRₚₐₜₕ) according to Equation 3:

$${PLR}_{path} = \frac{{N}_{loss}}{{N}_{loss} + {N}_{received}} \qquad Equation 3$$

where Nₗₒₛₛ is a quantity of missed SDUs associated with this respective path (indicated by the status reports 330) and N_{received} is a quantity of correctly received SDUs associated with this respective path (e.g., indicated by the status reports 330).

In either case (the UE 115-e receiving the PLR calculation, the UE 115-e calculating the PLR per path), the UE 115-e may determine the PLR calculation per communication path and transmit the traffic via the selected path. For example, the UE 115-e may determine, based on the PLR calculations, that the path with least failed messages (e.g., of the calculated paths) is the path including the UE 115-f.

In the example of FIG. 3B, the wireless communications system 300-b may support E2E PLR measurements via an RLC layer. For example, the UEs 115-h, 115-j, and 115-k may include multiple entities (e.g., transmitting entities, receiving entities) associated with a communication protocol stack (e.g., an L2 relay protocol stack). The protocol stack may at least include a PDCP layer, an SRAP layer, and an RLC layer. The UE 115-h may establish one or more E2E communication paths between the UE 115-h and the UE 115-k (e.g., path 240-a, path 240-b). One of the communication paths may utilize the UE 115-j as a relay UE 115. For example, the communication path may include an E2E link 345 that further includes a link 350-a between the UE 115-h and the UE 115-j and a link 350-b between the UE 115-j and the UE 115-k. In some cases, the UE 115-h may determine which communication path of a multi-path connection to utilize for transmitting traffic based on the E2E PLR measurements of each path.

In some cases, the transmitting UE 115 (e.g., the UE 115-h, the UE 115-j) may calculate the E2E PLR measurement based on a quantity of successfully (or unsuccessfully) received packets. For example, the UE 115-h may calculate PLR based on a quantity of E2E successfully or unsuccessfully received RLC packets (e.g., a sum of packets received on the link 350-a and the link 350-b) and a total quantity of transmitted RLC packets.

In some cases, a quantity of packets received per link 350 (e.g., per hop) is calculated by a transmitting RLC entity. For example, the UE 115-h may transmit RLC packets 360-a to the UE 115-j. An RLC entity 355-a of the UE 115-h may count a quantity of successfully transmitted RLC packets, a quantity of unsuccessfully transmitted RLC packets, or both, for the link 350-a based on respective packets of the RLC packets 360-a satisfying a retransmission threshold. For example, the UE 115-h may determine to retransmit an RLC packet (e.g., due to a lack of feedback, a NACK). If the retransmission of the RLC packet satisfies a max retransmission threshold, the UE 115-h may determine that the RLC packet was unsuccessfully transmitted (e.g., unsuccessfully received). In a similar manner, the UE 115-j may transmit RLC packets 360-b to the UE 115-k. The RLC entity 355-b (e.g., a transmitting entity, a receiving entity) may count the quantity of successfully (or unsuccessfully) transmitted RLC packets for the link 350-b and send (e.g., report) a message 365-a indicating the quantity to the RLC entity 355-a.

Alternatively, the quantity of packets received per link is calculated by a receiving RLC entity. For example, the UE 115-h may transmit RLC packets 360-a to the UE 115-j. The RLC entity 355-b of the UE 115-j may count a quantity of successfully received RLC packets, a quantity of unsuccessfully received RLC packets, or both, for the link 350-a based on a sequence number, a count value, or both, associated with the RLC packets 360-a. For example, because the count value or sequence number is incremented for each RLC packet, if a difference between a second count value or sequence number associated with a second packet and a first count value or sequence number associated with a first packet received prior to the second packet is greater than a quantity (e.g., greater than two), then the UE 115-j may determine one or more unsuccessfully received packets. The UE 115-j may then send the calculated quantity to the RLC entity 355-a of the UE 115-h. In a similar manner, the UE 115-j may transmit RLC packets 360-b to the UE 115-k. An RLC entity 355-c may count the quantity of successfully (e.g., unsuccessfully) received RLC packets for the link 350-b and send (e.g., report) the quantity to the RLC entity 355-b.

In either case (e.g., calculation performed at the transmitting RLC entity or the receiving RLC entity), the UE 115-h may combine the two quantities (e.g., the first quantity associated with the link 350-a and the second quantity associated with the link 350-b) to calculate the E2E PLR measurement (e.g., according to Equation 2, where the denominator may be replaced with the total quantity of unique packets transmitted). The UE 115-h may then select a path of the communication paths to transmit the traffic. For example, the UE 115-h may determine, based on the PLR calculations, that the path with least failed messages is the path including the UE 115-j.

Additionally, or alternatively, the transmitting UE 115 (e.g., the UE 115-h, the UE 115-j) may calculate the E2E PLR measurement based on a packet rate per link 350. For example, the receiving UE 115 (e.g., the UE 115-j, the UE 115-k) may calculate the packet rate according to Equation 4 or Equation 5:

$${R}_{successful} = \frac{{N}_{successful}}{{N}_{unsuccessful} + {N}_{successful}} \qquad Equation 4$$

$${R}_{unsuccessful} = \frac{{N}_{unsuccessful}}{{N}_{unsuccessful} + {N}_{successful}} \qquad Equation 5$$

where R_{successful} is a rate of successfully transmitted packets, R_{unsuccessful} is a rate of unsuccessfully transmitted packets, N_{unsuccessful} is a quantity of unsuccessfully transmitted packets, and N_{successful} is a quantity of successfully transmitted packets.

For instance, the UE 115-j may receive the packets 360-a and determine N_{unsuccessful} and N_{successful} for the link 350-a based on one or more sequence numbers, one or more count values, or both. The UE 115-j may then calculate a first rate associated with the link 350-a. Additionally, the UE 115-k may receive the packets 360-b and determine N_{unsuccessful} and N_{successful} for the link 350-b. The UE 115-k may then calculate a second rate associated with the link 350-b and send, to the UE 115-j, a message 365-b indicating the second rate. The UE 115-j may send, to the UE 115-k, a message 365-a indicating the first rate, the second rate, or both (e.g., a combination of the first rate and the second rate). The UE 115-h may calculate the PLR measurement associated with the E2E link 345 according to Equation 6 or Equation 7:

$$PLR = ( 1 - ( R {1}_{successful} * R {2}_{successful} ) ) \qquad Equation 6$$

$$PLR = ( 1 - ( 1 - R {1}_{unsuccessful} ) * ( 1 - R {2}_{unsuccessful} ) ) \qquad Equation 7$$

where R1 is the first rate and R2 is the second rate. Alternatively, the UE 115-j may calculate an accumulated rate (e.g., R′ successful, R′unsuccessful) based on a combination of the first rate and the second rate and send the accumulated rate to the UE 115-h.

Alternatively, the UE 115-h may transmit the packets 360-a and determine N_{unsuccessful} and N_{successful} for the link 350-a based on respective packets satisfying a retransmission threshold. The UE 115-h may then calculate a first rate associated with the link 350-a. Additionally, the UE 115-j may transmit the packets 360-b and determine N_{unsuccessful} and N_{successful} for the link 350-b based on the retransmission threshold. The UE 115-j may then calculate a second rate associated with the link 350-b and send, to the UE 115-h, a message 365-b indicating the second rate. The UE 115-h may calculate the PLR measurement associated with the E2E link 345 according to Equation 6 or Equation 7. In similar manners as described herein, the receiving UE 115 (e.g., the UE 115-j, the UE 115-k) may calculate the E2E PLR measurements.

FIG. 4 illustrates an example of a process flow 400 that supports measuring performance of E2E communication paths in U2U relay in accordance with one or more aspects of the present disclosure. In some examples, the process flow 400 may implement or be implemented by aspects of the wireless communications systems 100, 200, and 300-a, as described herein with reference to FIGS. 1 through 3A. For example, the process flow 400 may be implemented by a UE 115-1, one or more UEs 115-m, and a UE 115-n, which may be respective examples of a source UE 115, a relay UE 115, and a destination UE 115, as described with reference to FIGS. 1 through 3A. In the following description of the process flow 400, the operations between the UE 115-1, the UE 115-m, and the UE 115-n may be transmitted in a different order than the example order shown, or the operations performed by the UE 115-1, the UE 115-m, and the UE 115-n may be performed in different orders or at different times. Some operations may also be omitted from the process flow 400, and other operations may be added to the process flow 400.

At 405, the UE 115-n may optionally determine a configuration. For example, the configuration may be preconfigured, indicated by a network entity 105 (e.g., via a message indicating the configuration), indicated by the UE 115-1, another remote UE 115, or any combination thereof. In some cases, the configuration may be associated with determining to transmit a response message associated with an RTT request message (e.g., determine which request to respond to), as described herein with reference to FIGS. 2 and 3A. In some cases, the configuration may indicate a window duration associated with communicating the response message, where the response message includes a status report. In some examples, the configuration may indicate to transmit a respective status report including a sequence number, a count value, or both, associated with one or more RTT request messages. The status report may be associated with the one or more RTT request messages received during the window duration (e.g., transmitted in response to). In some cases, the UE 115-n may calculate the sequence number count based on an index value, the window duration, and an initial sequence number associated with a respective RTT request message (e.g., according to Equation 1).

At 410, the UE 115-1 may establish an E2E link with the UE 115-n for communicating traffic, the E2E link including multiple paths (e.g., multi-path connection), where each path may include one or more sidelink communication links (e.g., links 350). For example, a first path may include a first link to the UE 115-m and a second link between the UE 115-m and the UE 115-n. A second path may include various links between the UE 115-1, one or more relay UEs 115, and the UE 115-n.

At 415, the UE 115-1 may communicate, with the UE 115-n via the first path, a first message associated with measuring an RTT for the first path. For example, the UE 115-1 may transmit the first message to the UE 115-m, which may relay the first message to the UE 115-n. The first message may be a first PDU of a PDCP layer that includes a first header configured for measuring RTT, an SDU associated with an RTT request, or both. At 420, the UE 115-1 may store a first timestamp associated with transmitting the first message.

At 425, the UE 115-n may communicate, with the UE 115-1 via the first path, a second message associated with measuring the RTT for the first path. For example, the UE 115-n may transmit the second message to the UE 115-m, which may relay the second message to the UE 115-1. The second message may be a second PDU of the PDCP layer that includes a second header configured for measuring RTT, an SDU associated with an RTT response, or both. In some cases, the UE 115-n may transmit the second message in a next available transmission time resource subsequent to receiving the first message.

At 430, the UE 115-1 may calculate the RTT associated with the first path of the E2E link based on communicating the first message and the second message. For example, the UE 115-1 may determine a second timestamp associated with receiving the second message and calculate a difference between the first timestamp and the second timestamp to determine the RTT measurement. At 435, the UE 115-1, the UE 115-m, and the UE 115-n may communicate based on calculating the RTT measurement. For example, the UE 115-1 may determine that the RTT measurement associated with the first path (e.g., the path including the UE 115-m) satisfies a path threshold (e.g., is less than other RTT measurements associated with other paths) and select the first path to communicate traffic with the UE 115-n.

FIG. 5 illustrates an example of a process flow 500 that supports measuring performance of E2E communication paths in U2U relay in accordance with one or more aspects of the present disclosure. In some examples, the process flow 500 may implement or be implemented by aspects of the wireless communications systems 100, 200, and 300-a, as described herein with reference to FIGS. 1 through 3A. For example, the process flow 500 may be implemented by a UE 115-0, one or more UEs 115-p, and a UE 115-q, which may be respective examples of a source UE 115, a relay UE 115, and a destination UE 115, as described with reference to FIGS. 1 through 4. In the following description of the process flow 500, the operations between the UE 115-0, the UE 115-p, and the UE 115-q may be transmitted in a different order than the example order shown, or the operations performed by the UE 115-0, the UE 115-p, and the UE 115-q may be performed in different orders or at different times. Some operations may also be omitted from the process flow 500, and other operations may be added to the process flow 500.

At 505, the UE 115-0, the UE 115-q, or both may optionally determine a configuration. For example, the configuration may be preconfigured, indicated by a network entity 105 (e.g., via a message indicating the configuration), indicated by the UE 115-o, another remote UE 115, or any combination thereof. In some cases, the configuration may indicate a window duration associated with communicating one or more messages associated with packet loss, as described herein with reference to FIGS. 2 and 3A.

At 510, the UE 115-o may establish an E2E link with the UE 115-q for communicating traffic, the E2E link including multiple paths (e.g., multi-path connection), where each path may include one or more sidelink communication links (e.g., links 350). For example, a first path may include a first link to the UE 115-p and a second link between the UE 115-p and the UE 115-q. A second path may include various links between the UE 115-0, one or more relay UEs 115, and the UE 115-q.

At 515, the UE 115-o may optionally transmit, to the UE 115-q, a first message indicating to start a path loss measurement procedure. At 535, the UE 115-0 may optionally transmit, to the UE 115-q, a second message indicating to stop the path loss measurement procedure. For example, the window duration associated with communicating the one or more messages associated with packet loss may start and end according to indications of the first message and the second message.

At 520, the UE 115-o may transmit, to the UE 115-q, multiple messages, some of which may experience packet loss. For example, the UE 115-o may transmit the messages to the UE 115-p, which may relay the messages to the UE 115-q. In some cases, the multiple messages may include SDUs of a PDCP layer (e.g., PLR packets). The UE 115-q may receive the multiple messages via the first path of the E2E link.

At 525, the UE 115-q may optionally calculate a metric associated with packet loss for the first path based on receiving the one or more messages during the window duration and a quantity of total messages of a sequence of messages associated with the one or more messages. For example, the quantity of total messages may include a counting of how many SDUs the UE 115-o transmitted, where the sequence of messages are the messages transmitted during the window duration.

In some cases, the UE 115-q may determine a quantity of unsuccessful messages associated with the one or more messages during the window duration based on one or more sequence numbers, one or more count values, or both, associated with the one or more messages, as described herein with reference to FIGS. 2 and 3A. The UE 115-q may calculate the quantity of total messages based on a combination (e.g., an addition) of the quantity of unsuccessful messages and a quantity of successful messages associated with the one or more messages during the window duration (e.g., Equation 2 denominator). The UE 115-q may calculate the metric based on a difference (e.g., ratio) between the quantity of unsuccessful messages and the quantity of total messages (e.g., Equation 2).

In some cases, the UE 115-q may calculate a respective metric for each radio bearer of a set of radio bearers based on respective sets of messages for each radio bearer of the set of radio bearers and a respective quantity of total messages for each radio bearer. In some implementations, the UE 115-q may calculate a respective metric associated with each path of the multiple paths based on a respective quantity of unsuccessful messages associated with each path and a respective quantity of successful messages associated with each path. In some examples, before calculating the metric, the UE 115-q may reorder the one or more messages based on a respective sequence number for each of the one or more messages.

At 530, the UE 115-q may transmit one or more messages associated with packet loss. For example, the UE 115-q may transmit, to the UE 115-0, a message indicating the calculated metric associated with packet loss via an RRC layer of a communication protocol stack, a PDCP layer of the protocol stack, or both. Alternatively, the UE 115-q may transmit, to the UE 115-o one or more status reports. In some cases, the one or more status reports may include respective status reports configured by a network entity 105 for each SDU of the multiple messages received by the UE 115-q during a second window duration (e.g., T′) included in the window duration (e.g., T) each SDU of the multiple messages during a first periodic window duration (e.g., P′) comprising the window duration (e.g., P), or each successful SDU of the multiple messages during a second period window duration (e.g., P′) comprising the window duration (e.g., P), where the respective status reports indicate an unsuccessful message or a successful message.

At 540, the UE 115-o may optionally calculate the metric associated with packet loss for the first path based on receiving the one or more messages during the window duration and the quantity of total messages of the sequence of messages associated with the one or more messages, as described herein at 525. At 545, the UE 115-o, the UE 115-p, and the UE 115-q may communicate based on calculating the PLR measurement. For example, the UE 115-o may determine that the PLR measurement associated with the first path (e.g., the path including the UE 115-p) satisfies a path threshold (e.g., is less than other PLR measurements associated with other paths) and select the first path to communicate traffic with the UE 115-q.

FIG. 6 illustrates an example of a process flow 600 that supports measuring performance of E2E communication paths in U2U relay in accordance with one or more aspects of the present disclosure. In some examples, the process flow 600 may implement or be implemented by aspects of the wireless communications systems 100, 200, and 300-b, as described herein with reference to FIGS. 1, 2, and 3B. For example, the process flow 600 may be implemented by a UE 115-r, a UE 115-s, and a UE 115-t, which may be respective examples of a source UE 115, a relay UE 115, and a destination UE 115, as described with reference to FIGS. 1 through 4. In the following description of the process flow 600, the operations between the UE 115-r, the UE 115-s, and the UE 115-t may be transmitted in a different order than the example order shown, or the operations performed by the UE 115-r, the UE 115-s, and the UE 115-t may be performed in different orders or at different times. Some operations may also be omitted from the process flow 600, and other operations may be added to the process flow 600.

At 605, the UE 115-r may establish a first link (e.g., an E2E link) with the UE 115-t for communicating traffic, the E2E link including multiple paths (e.g., multi-path connection), where each path may include one or more sidelink communication links (e.g., links 350). For example, a first path may include a second link to the UE 115-s and a third link between the UE 115-s and the UE 115-t. A second path may include various links between the UE 115-r, one or more relay UEs 115, and the UE 115-t.

At 610, the UE 115-r may transmit, to the UE 115-t via the second link, multiple messages during a first window duration, some of which may experience packet loss. For example, the UE 115-r may transmit, to the UE 115-s, a first set of messages associated with an RLC layer of a communication protocol stack. In some cases, the UE 115-r may determine a first quantity of successful messages associated with the second link and the first set, a second quantity of unsuccessful messages associated with the second link and the first set, or both, based on a threshold (e.g., a max retransmission threshold) associated with retransmission being satisfied. In some cases, the UE 115-s may determine the first quantities based on one or more sequence numbers, one or more count values, or both.

At 610, the UE 115-s may receive (e.g., at an RLC entity) the messages and transmit a second set of messages associated with packet loss to the UE 115-t during a second window duration. In some cases, the UE 115-s may determine a second quantity of successful messages associated with the third link and the second set, a second quantity of unsuccessful messages associated with the third link and the second set, or both, based on the threshold associated with retransmission being satisfied. In some cases, the UE 115-t may determine the second quantities based on a sequence number, a count value, or both.

At 615, the UE 115-t may optionally calculate an E2E metric associated with packet loss based on receiving the one or more messages during the window duration and a quantity of total messages associated with the one or more messages. For example, the quantity of total messages may include a counting of how many SDUs the UE 115-r and the UE 115-s transmitted respectively. In some cases, the UE 115-t may calculate the metric based on a combination of a first quantity of unsuccessful messages associated with the first set and a second quantity of unsuccessful messages associated with the second set, or based on a combination of a first quantity of successful messages associated with the first set and a second quantity of successful messages associated with the second set.

In some cases, the UE 115-t may calculate the metric based on a second metric (e.g., a packet rate) associated with the first set and a third metric associated with the second set. For example, calculating the second metric and the third metric may include calculating the quantity of total messages based on a combination of the first quantity of unsuccessful messages and a first quantity of successful messages associated with the one or more messages (e.g., either the first set or the second set) and calculating a separation between the first quantity of successful messages and the quantity of total messages (e.g., according to Equation 4) or a separation between the first quantity of unsuccessful messages and the quantity of total messages (e.g., according to Equation 5).

In some examples, the UE 115-t may calculate the metric based on the second metric and the third metric. For example, the UE 115-t may calculate a first difference between a first value (e.g., an integer value, one) and the second metric, a second difference between a second value (e.g., an integer value, one) and the third metric, and a third difference between a third value (e.g., an integer value, one) and a product of the first difference and the second difference (e.g., according to Equation 7). In some cases, the UE 115-t may calculate the metric based on a difference between the first value and a product of the first metric and the second metric (e.g., according to Equation 6).

At 620, the UE 115-s may receive, from the UE 115-t via an RLC layer, a message indicating the second quantity of unsuccessful messages associated with the third link, the second quantity of successful messages associated with the third link, or both. Alternatively, the UE 115-s may receive, from the UE 115-t, a message indicating the first metric. At 625, the UE 115-s may optionally calculate the first metric as described herein at 615.

At 630, the UE 115-r may receive, from the UE 115-s via an RLC layer, a message indicating the second quantity of unsuccessful messages associated with the third link, the second quantity of successful messages associated with the third link, or both. Alternatively, the UE 115-r may receive, from the UE 115-s, a message indicating the first metric. At 635, the UE 115-r may optionally calculate the first metric as described herein at 615. At 640, the UE 115-r, the UE 115-s, and the UE 115-t may communicate based on calculating the first metric (e.g., the E2E PLR measurement). For example, the UE 115-r may determine that the PLR measurement associated with the first path (e.g., the path including the UE 115-s) satisfies a path threshold (e.g., is less than other PLR measurements associated with other paths) and select the first path to communicate traffic with the UE 115-t.

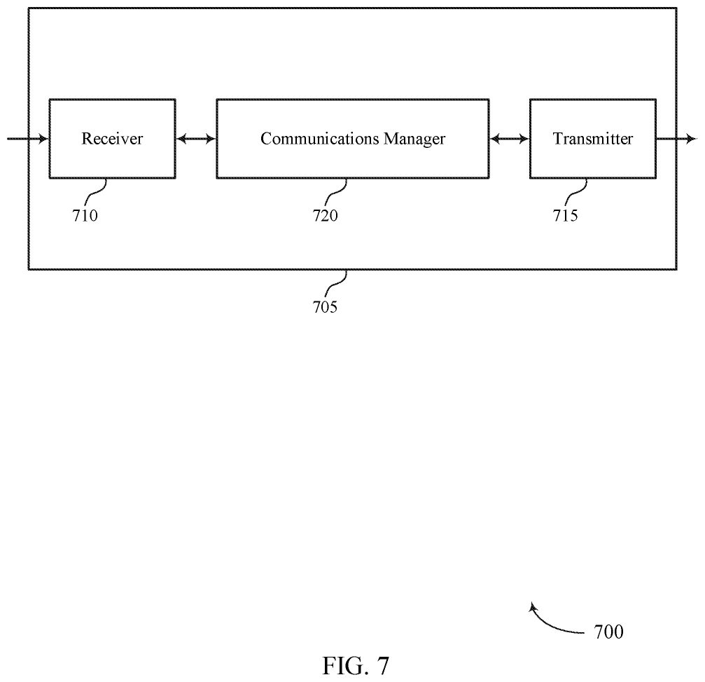

FIG. 7 illustrates a block diagram 700 of a device 705 that supports measuring performance of E2E communication paths in U2U relay in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to measuring performance of E2E communication paths in U2U relay). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to measuring performance of E2E communication paths in U2U relay). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of measuring performance of E2E communication paths in U2U relay as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE in accordance with examples as disclosed herein. For example, the communications manager 720 may be configured as or otherwise support a means for establishing an E2E link with a second UE for communicating traffic, the E2E link including a set of multiple paths, each of the set of multiple paths including one or more sidelink communication links. The communications manager 720 may be configured as or otherwise support a means for communicating, with the second UE via a first path of the set of multiple paths of the E2E link, a first message associating with measuring a RTT for the first path of the E2E link. The communications manager 720 may be configured as or otherwise support a means for communicating a second message via the first path of the E2E link based on communicating the first message. The communications manager 720 may be configured as or otherwise support a means for calculating the RTT associated with the first path of the E2E link based on communicating the first message and the second message.

Additionally, or alternatively, the communications manager 720 may support wireless communication at a first UE in accordance with examples as disclosed herein. For example, the communications manager 720 may be configured as or otherwise support a means for establishing an E2E link with a second UE for communicating traffic, the E2E link including a set of multiple paths, each of the set of multiple paths including one or more sidelink communication links. The communications manager 720 may be configured as or otherwise support a means for receiving, via a first path of the E2E link, one or more messages during a window duration. The communications manager 720 may be configured as or otherwise support a means for calculating a metric associated with packet loss for the first path based on receiving the one or more messages during the window duration and a quantity of total messages of a sequence of messages associated with the one or more messages.

Additionally, or alternatively, the communications manager 720 may support wireless communication at a first UE in accordance with examples as disclosed herein. For example, the communications manager 720 may be configured as or otherwise support a means for establishing a first E2E link between the first UE and a second UE, where the first link includes a second link between the first UE and a third UE that is configured to relay communications between the first UE and the second UE. The communications manager 720 may be configured as or otherwise support a means for transmitting, to the second UE via the second link, one or more messages during a window duration. The communications manager 720 may be configured as or otherwise support a means for determining a first quantity of unsuccessful messages associated with the second link, a first quantity of successful messages associated with the second link, or both, based on transmitting the one or more messages. The communications manager 720 may be configured as or otherwise support a means for calculating a metric associated with packet loss based on transmitting the one or more messages during the window duration and a quantity of total messages associated with the one or more messages.

Additionally, or alternatively, the communications manager 720 may support wireless communication at a third UE in accordance with examples as disclosed herein. For example, the communications manager 720 may be configured as or otherwise support a means for establishing a second link between the third UE and a first UE and a third link between the third UE and a second UE, where the second link and the third link are included in a first E2E link between the first UE and the second UE and the third UE is configured to relay communications between the first UE and the second UE. The communications manager 720 may be configured as or otherwise support a means for receiving, from the first UE via the second link, a first set of one or more messages during a first window duration. The communications manager 720 may be configured as or otherwise support a means for transmitting, to the second UE via the third link, a second set of one or more messages during a second window duration. The communications manager 720 may be configured as or otherwise support a means for transmitting, to the first UE via the second link, a quantity associated with packet loss based on receiving the first set and transmitting the second set.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced latency, reduced quantity of failed transmission, and more efficient utilization of communication resources.

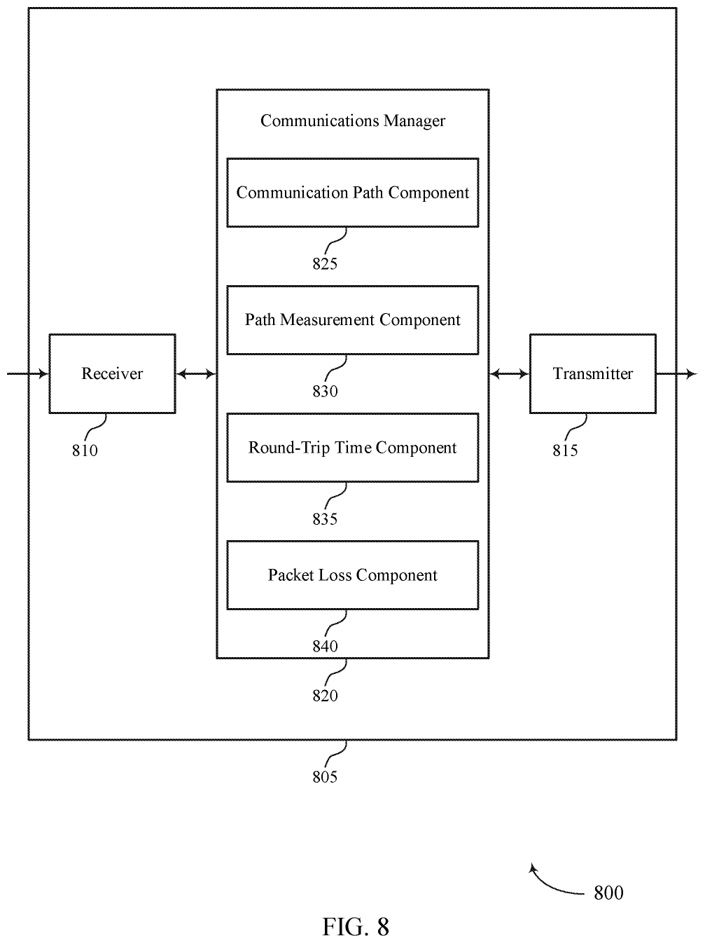

FIG. 8 illustrates a block diagram 800 of a device 805 that supports measuring performance of E2E communication paths in U2U relay in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to measuring performance of E2E communication paths in U2U relay). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to measuring performance of E2E communication paths in U2U relay). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of measuring performance of E2E communication paths in U2U relay as described herein. For example, the communications manager 820 may include a communication path component 825, a path measurement component 830, a RTT component 835, a packet loss component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first UE in accordance with examples as disclosed herein. The communication path component 825 may be configured as or otherwise support a means for establishing an E2E link with a second UE for communicating traffic, the E2E link including a set of multiple paths, each of the set of multiple paths including one or more sidelink communication links. The path measurement component 830 may be configured as or otherwise support a means for communicating, with the second UE via a first path of the set of multiple paths of the E2E link, a first message associated with measuring a RTT for the first path of the E2E link. The path measurement component 830 may be configured as or otherwise support a means for communicating a second message via the first path of the E2E link based on communicating the first message. The RTT component 835 may be configured as or otherwise support a means for calculating the RTT associated with the first path of the E2E link based on communicating the first message and the second message.

Additionally, or alternatively, the communications manager 820 may support wireless communication at a first UE in accordance with examples as disclosed herein. The communication path component 825 may be configured as or otherwise support a means for establishing an E2E link with a second UE for communicating traffic, the E2E link including a set of multiple paths, each of the set of multiple paths including one or more sidelink communication links. The path measurement component 830 may be configured as or otherwise support a means for receiving, via a first path of the E2E link, one or more messages during a window duration. The packet loss component 840 may be configured as or otherwise support a means for calculating a metric associated with packet loss for the first path based on receiving the one or more messages during the window duration and a quantity of total messages of a sequence of messages associated with the one or more messages.

Additionally, or alternatively, the communications manager 820 may support wireless communication at a first UE in accordance with examples as disclosed herein. The communication path component 825 may be configured as or otherwise support a means for establishing a first E2E link between the first UE and a second UE, where the first link includes a second link between the first UE and a third UE that is configured to relay communications between the first UE and the second UE. The path measurement component 830 may be configured as or otherwise support a means for transmitting, to the second UE via the second link, one or more messages during a window duration. The packet loss component 840 may be configured as or otherwise support a means for determining a first quantity of unsuccessful messages associated with the second link, a first quantity of successful messages associated with the second link, or both, based on transmitting the one or more messages. The packet loss component 840 may be configured as or otherwise support a means for calculating a metric associated with packet loss based on transmitting the one or more messages during the window duration and a quantity of total messages associated with the one or more messages.

Additionally, or alternatively, the communications manager 820 may support wireless communication at a third UE in accordance with examples as disclosed herein. The communication path component 825 may be configured as or otherwise support a means for establishing a second link between the third UE and a first UE and a third link between the third UE and a second UE, where the second link and the third link are included in a first E2E link between the first UE and the second UE and the third UE is configured to relay communications between the first UE and the second UE. The path measurement component 830 may be configured as or otherwise support a means for receiving, from the first UE via the second link, a first set of one or more messages during a first window duration. The path measurement component 830 may be configured as or otherwise support a means for transmitting, to the second UE via the third link, a second set of one or more messages during a second window duration. The packet loss component 840 may be configured as or otherwise support a means for transmitting, to the first UE via the second link, a quantity associated with packet loss based on receiving the first set and transmitting the second set.

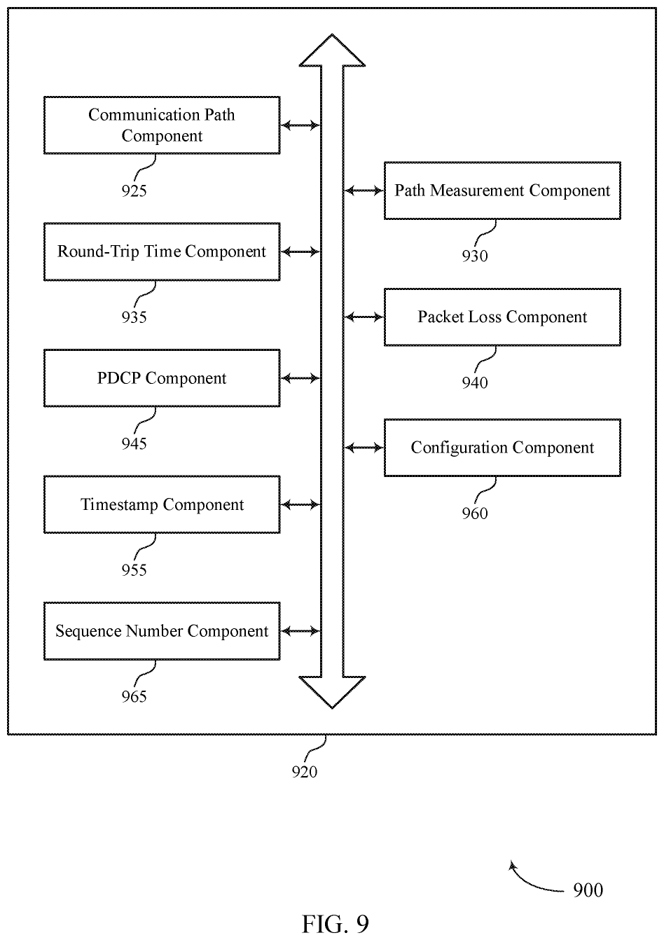

FIG. 9 illustrates a block diagram 900 of a communications manager 920 that supports measuring performance of E2E communication paths in U2U relay in accordance with one or more aspects of the present disclosure. The communications manager 920 may be an example of aspects of a communications manager 720, a communications manager 820, or both, as described herein. The communications manager 920, or various components thereof, may be an example of means for performing various aspects of measuring performance of E2E communication paths in U2U relay as described herein. For example, the communications manager 920 may include a communication path component 925, a path measurement component 930, a RTT component 935, a packet loss component 940, a PDCP component 945, a timestamp component 955, a configuration component 960, a sequence number component 965, or any combination thereof. Each of these components may communicate, directly or indirectly, with one another (e.g., via one or more buses).

The communications manager 920 may support wireless communication at a first UE in accordance with examples as disclosed herein. The communication path component 925 may be configured as or otherwise support a means for establishing an E2E link with a second UE for communicating traffic, the E2E link including a set of multiple paths, each of the set of multiple paths including one or more sidelink communication links. The path measurement component 930 may be configured as or otherwise support a means for communicating, with the second UE via a first path of the set of multiple paths of the E2E link, a first message associated with measuring a RTT for the first path of the E2E link. In some examples, the path measurement component 930 may be configured as or otherwise support a means for communicating a second message via the first path of the E2E link based on communicating the first message. The RTT component 935 may be configured as or otherwise support a means for calculating the RTT associated with the first path of the E2E link based on communicating the first message and the second message.

In some examples, the PDCP component 945 may be configured as or otherwise support a means for communicating with the second UE based on calculating the RTT, where the first message and the second message are associated with a PDCP layer of a communication protocol stack.

In some examples, the first message is a first PDU of a PDCP layer that includes a first header configured for measuring RTTs, a SDU associated with a RTT request, or both. In some examples, the second message is a second PDU of the PDCP layer that includes a second header configured for measuring RTTs, a SDU associated with a RTT response, or both.

In some examples, the timestamp component 955 may be configured as or otherwise support a means for storing a first timestamp associated with transmitting the first message, where calculating the RTT associated with the E2E link includes. In some examples, the RTT component 935 may be configured as or otherwise support a means for calculating a difference between a second timestamp associated with receiving the second message and the first timestamp.

In some examples, the configuration component 960 may be configured as or otherwise support a means for receiving, from a network entity, a message including a configuration, where the second message is associated with the first message based on the configuration.

In some examples, the configuration component 960 may be configured as or otherwise support a means for receiving, from a network entity, a message including a configuration indicating a window duration associated with communicating the second message, the second message including a status report.

In some examples, the configuration indicates to transmit a respective status report for one or more round-trip request messages received during the window duration, the respective status report including a sequence number, a count value, or both, associated with the one or more round-trip request messages. In some examples, the one or more round-trip request messages includes the first message.

In some examples, the sequence number component 965 may be configured as or otherwise support a means for calculating a sequence number count based on an index value, the window duration, and an initial sequence number associated with a first round-trip request message, where the status report includes the sequence number count.

In some examples, to support communicating the second message, the path measurement component 930 may be configured as or otherwise support a means for transmitting the second message in a next available transmission time resource subsequent to receiving the first message.

Additionally, or alternatively, the communications manager 920 may support wireless communication at a first UE in accordance with examples as disclosed herein. In some examples, the communication path component 925 may be configured as or otherwise support a means for establishing an E2E link with a second UE for communicating traffic, the E2E link including a set of multiple paths, each of the set of multiple paths including one or more sidelink communication links. In some examples, the path measurement component 930 may be configured as or otherwise support a means for receiving, via a first path of the E2E link, one or more messages during a window duration. The packet loss component 940 may be configured as or otherwise support a means for calculating a metric associated with packet loss for the first path based on receiving the one or more messages during the window duration and a quantity of total messages of a sequence of messages associated with the one or more messages.

In some examples, the one or more messages are associated with a PDCP layer of a communication protocol stack.

In some examples, the path measurement component 930 may be configured as or otherwise support a means for transmitting, to the second UE, the calculated metric associated with packet loss via a radio resource control layer of the communication protocol stack, the PDCP layer of the communication protocol stack, or both.

In some examples, to support calculating the metric associated with packet loss, the packet loss component 940 may be configured as or otherwise support a means for determining a quantity of unsuccessful messages associated with the one or more messages during the window duration based on one or more sequence numbers, one or more count values, or both, associated with the one or more messages. In some examples, to support calculating the metric associated with packet loss, the packet loss component 940 may be configured as or otherwise support a means for calculating the quantity of total messages based on a combination of the quantity of unsuccessful messages and a quantity of successful messages associated with the one or more messages during the window duration. In some examples, to support calculating the metric associated with packet loss, the packet loss component 940 may be configured as or otherwise support a means for calculating the metric based on a separation between the quantity of unsuccessful messages and the quantity of total messages.

In some examples, to support calculating the metric associated with packet loss, the packet loss component 940 may be configured as or otherwise support a means for calculating a respective metric for each radio bearer of a set of radio bearers based on respective sets of messages for each radio bearer of the set of radio bearers and a respective quantity of total messages for each radio bearer of the set of radio bearers.

In some examples, the sequence number component 965 may be configured as or otherwise support a means for reordering the one or more messages based on a respective sequence number for each of the one or more messages, where calculating the metric associated with packet loss is further based on reordering the one or more messages.

In some examples, the configuration component 960 may be configured as or otherwise support a means for receiving, from a network entity, the second UE, or both, a configuration indicating the window duration, where calculating the metric associated with packet loss is further based on the configuration.

In some examples, the one or more messages include SDUs of the PDCP layer.

In some examples, the path measurement component 930 may be configured as or otherwise support a means for transmitting, to the second UE, a set of multiple messages associated with packet loss, where receiving the one or more messages is based on transmitting the set of multiple messages, the set of multiple messages including SDUs of the PDCP layer.

In some examples, the one or more messages include respective status reports configured by a network entity for each SDU of the set of multiple messages during a second window duration included in the window duration, each SDU of the set of multiple messages during a first periodic window duration including the window duration, or each successful SDU of the set of multiple messages during a second periodic window duration including the window duration, the respective status reports indicating an unsuccessful message or a successful message.

In some examples, the path measurement component 930 may be configured as or otherwise support a means for transmitting, to the second UE, a first message indicating to start a path loss measurement procedure based on establishing the E2E link and a second message indicating to stop the path loss measurement procedure based on receiving the one or more messages, where the window duration is associated with the indication to start and the indication to stop.

In some examples, to support calculating the metric associated with packet loss, the packet loss component 940 may be configured as or otherwise support a means for calculating a respective metric associated with each path of the set of multiple paths based on a respective quantity of unsuccessful messages associated with each path and a respective quantity of successful messages associated with each path, the respective quantity of unsuccessful messages, the respective quantity of successful messages, or both, indicated by the one or more messages.

Additionally, or alternatively, the communications manager 920 may support wireless communication at a first UE in accordance with examples as disclosed herein. In some examples, the communication path component 925 may be configured as or otherwise support a means for establishing a first E2E link between the first UE and a second UE, where the first link includes a second link between the first UE and a third UE that is configured to relay communications between the first UE and the second UE. In some examples, the path measurement component 930 may be configured as or otherwise support a means for transmitting, to the second UE via the second link, one or more messages during a window duration. In some examples, the packet loss component 940 may be configured as or otherwise support a means for determining a first quantity of unsuccessful messages associated with the second link, a first quantity of successful messages associated with the second link, or both, based on transmitting the one or more messages. In some examples, the packet loss component 940 may be configured as or otherwise support a means for calculating a metric associated with packet loss based on transmitting the one or more messages during the window duration and a quantity of total messages associated with the one or more messages.

In some examples, the path measurement component 930 may be configured as or otherwise support a means for receiving, from the third UE via a radio link control layer, a message indicating a second quantity of unsuccessful messages associated with a third link between the third UE and the second UE, a second quantity of successful messages associated with the third link, or both, where determining the first quantity of unsuccessful messages or the first quantity of successful messages is further based on a threshold associated with retransmission being satisfied.

In some examples, to support calculating the metric, the packet loss component 940 may be configured as or otherwise support a means for calculating the metric based on a combination of the first quantity of unsuccessful messages and the second quantity of unsuccessful messages, where the metric is associated with the first link. In some examples, to support calculating the metric, the packet loss component 940 may be configured as or otherwise support a means for calculating the metric based on a combination of the first quantity of successful messages and the second quantity of successful messages, where the metric is associated with the first link.

In some examples, to support determining the first quantity of unsuccessful messages or the first quantity of successful messages, the packet loss component 940 may be configured as or otherwise support a means for calculating the quantity of total messages based on a combination of the first quantity of unsuccessful messages and the first quantity of successful messages associated with the one or more messages. In some examples, to support determining the first quantity of unsuccessful messages or the first quantity of successful messages, the packet loss component 940 may be configured as or otherwise support a means for calculating a second metric associated with successfully received messages based on a separation between the first quantity of successful messages and the quantity of total messages.

In some examples, the path measurement component 930 may be configured as or otherwise support a means for receiving, from the second UE, a message indicating a third metric associated with successfully received messages on a third link between the third UE and the second UE. In some examples, to calculate the metric associated with packet loss, the packet loss component 940 may be configured as or otherwise support a means for calculating a first difference between a first value and the second metric and a second difference between a second value and the third metric and the packet loss component 940 may be configured as or otherwise support a means for calculating a third difference between a third value and a product of the first difference and the second difference.

In some examples, the path measurement component 930 may be configured as or otherwise support a means for receiving, from the second UE, a message indicating a second metric associated with successfully received messages on the second link and a third metric associated with successfully received messages on a third link between the third UE and the second UE. In some examples, to the second metric, the packet loss component 940 may be configured as or otherwise support a means for calculating a first difference between a first value and the second metric and a second difference between a second value and the third metric and the packet loss component 940 may be configured as or otherwise support a means for calculating a third difference between a third value and a product of the first difference and the second difference.

In some examples, the one or more messages are associated with a radio link control layer of a communication protocol stack.

Additionally, or alternatively, the communications manager 920 may support wireless communication at a third UE in accordance with examples as disclosed herein. In some examples, the communication path component 925 may be configured as or otherwise support a means for establishing a second link between the third UE and a first UE and a third link between the third UE and a second UE, where the second link and the third link are included in a first E2E link between the first UE and the second UE and the third UE is configured to relay communications between the first UE and the second UE. In some examples, the path measurement component 930 may be configured as or otherwise support a means for receiving, from the first UE via the second link, a first set of one or more messages during a first window duration. In some examples, the path measurement component 930 may be configured as or otherwise support a means for transmitting, to the second UE via the third link, a second set of one or more messages during a second window duration. In some examples, the packet loss component 940 may be configured as or otherwise support a means for transmitting, to the first UE via the second link, a quantity associated with packet loss based on receiving the first set and transmitting the second set.

In some examples, the path measurement component 930 may be configured as or otherwise support a means for receiving, from the second UE via the third link, a first message indicating a first quantity of successful messages associated with the third link and the second set, a first quantity of unsuccessful messages associated with the third link and the second set, or both. In some examples, the packet loss component 940 may be configured as or otherwise support a means for determining a second quantity of successful messages associated with the second link and the first set, a second quantity of unsuccessful messages associated with the second link and the first set, or both, based on a threshold associated with retransmission being satisfied. In some examples, the packet loss component 940 may be configured as or otherwise support a means for calculating the quantity associated with packet loss based on a combination between the first quantity of successful messages and the second quantity of successful messages or a combination between the first quantity of unsuccessful messages and the second quantity of unsuccessful messages.

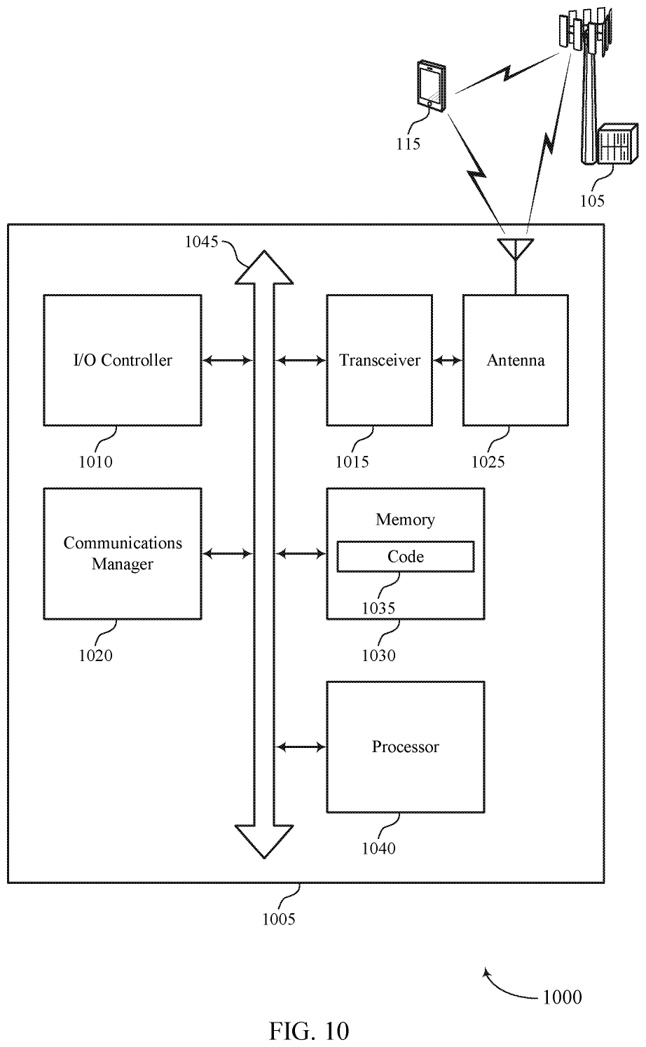

FIG. 10 illustrates a diagram of a system 1000 including a device 1005 that supports measuring performance of E2E communication paths in U2U relay in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting measuring performance of E2E communication paths in U2U relay). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first UE in accordance with examples as disclosed herein. For example, the communications manager 1020 may be configured as or otherwise support a means for establishing an E2E link with a second UE for communicating traffic, the E2E link including a set of multiple paths, each of the set of multiple paths including one or more sidelink communication links. The communications manager 1020 may be configured as or otherwise support a means for communicating, with the second UE via a first path of the set of multiple paths of the E2E link, a first message associating with measuring a RTT for the first path of the E2E link. The communications manager 1020 may be configured as or otherwise support a means for communicating a second message via the first path of the E2E link based on communicating the first message. The communications manager 1020 may be configured as or otherwise support a means for calculating the RTT associated with the first path of the E2E link based on communicating the first message and the second message.

Additionally, or alternatively, the communications manager 1020 may support wireless communication at a first UE in accordance with examples as disclosed herein. For example, the communications manager 1020 may be configured as or otherwise support a means for establishing an E2E link with a second UE for communicating traffic, the E2E link including a set of multiple paths, each of the set of multiple paths including one or more sidelink communication links. The communications manager 1020 may be configured as or otherwise support a means for receiving, via a first path of the E2E link, one or more messages during a window duration. The communications manager 1020 may be configured as or otherwise support a means for calculating a metric associated with packet loss for the first path based on receiving the one or more messages during the window duration and a quantity of total messages of a sequence of messages associated with the one or more messages.

Additionally, or alternatively, the communications manager 1020 may support wireless communication at a first UE in accordance with examples as disclosed herein. For example, the communications manager 1020 may be configured as or otherwise support a means for establishing a first E2E link between the first UE and a second UE, where the first link includes a second link between the first UE and a third UE that is configured to relay communications between the first UE and the second UE. The communications manager 1020 may be configured as or otherwise support a means for transmitting, to the second UE via the second link, one or more messages during a window duration. The communications manager 1020 may be configured as or otherwise support a means for determining a first quantity of unsuccessful messages associated with the second link, a first quantity of successful messages associated with the second link, or both, based on transmitting the one or more messages. The communications manager 1020 may be configured as or otherwise support a means for calculating a metric associated with packet loss based on transmitting the one or more messages during the window duration and a quantity of total messages associated with the one or more messages.

Additionally, or alternatively, the communications manager 1020 may support wireless communication at a third UE in accordance with examples as disclosed herein. For example, the communications manager 1020 may be configured as or otherwise support a means for establishing a second link between the third UE and a first UE and a third link between the third UE and a second UE, where the second link and the third link are included in a first E2E link between the first UE and the second UE and the third UE is configured to relay communications between the first UE and the second UE. The communications manager 1020 may be configured as or otherwise support a means for receiving, from the first UE via the second link, a first set of one or more messages during a first window duration. The communications manager 1020 may be configured as or otherwise support a means for transmitting, to the second UE via the third link, a second set of one or more messages during a second window duration. The communications manager 1020 may be configured as or otherwise support a means for transmitting, to the first UE via the second link, a quantity associated with packet loss based on receiving the first set and transmitting the second set.

By including or configuring the communications manager 1020 in accordance with examples as described herein, the device 1005 may support techniques for reduced latency, reduced quantity of failed transmission, and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of measuring performance of E2E communication paths in U2U relay as described herein, or the processor 1040 and the memory 1030 may be otherwise configured to perform or support such operations.

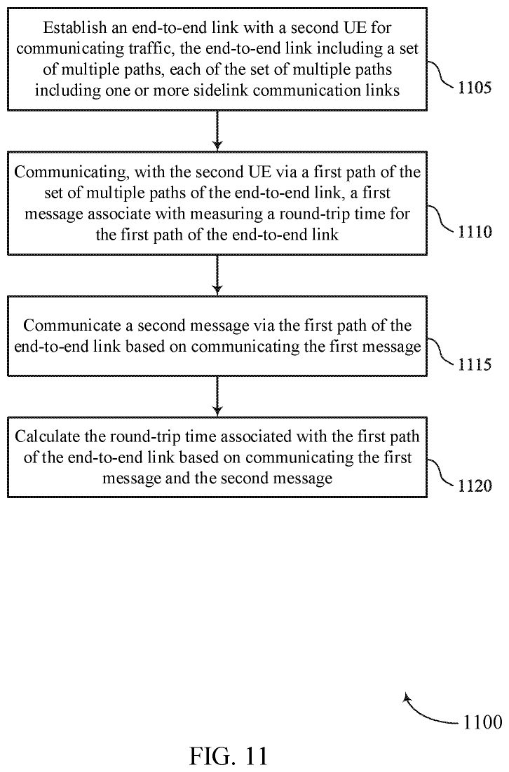

FIG. 11 illustrates a flowchart illustrating a method 1100 that supports measuring performance of E2E communication paths in U2U relay in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include establishing an E2E link with a second UE for communicating traffic, the E2E link including a set of multiple paths, each of the set of multiple paths including one or more sidelink communication links. The operations of 1105 may be performed in accordance with examples as disclosed herein. In some examples, aspects of the operations of 1105 may be performed by a communication path component 925 as described with reference to FIG. 9.

At 1110, the method may include communicating, with the second UE via a first path of the set of multiple paths of the E2E link, a first message associated with measuring a RTT for the first path of the E2E link. The operations of 1110 may be performed in accordance with examples as disclosed herein. In some examples, aspects of the operations of 1110 may be performed by a path measurement component 930 as described with reference to FIG. 9.

At 1115, the method may include communicating a second message via the first path of the E2E link based on communicating the first message. The operations of 1115 may be performed in accordance with examples as disclosed herein. In some examples, aspects of the operations of 1115 may be performed by a path measurement component 930 as described with reference to FIG. 9.

At 1120, the method may include calculating the RTT associated with the first path of the E2E link based on communicating the first message and the second message. The operations of 1120 may be performed in accordance with examples as disclosed herein. In some examples, aspects of the operations of 1120 may be performed by a RTT component 935 as described with reference to FIG. 9.

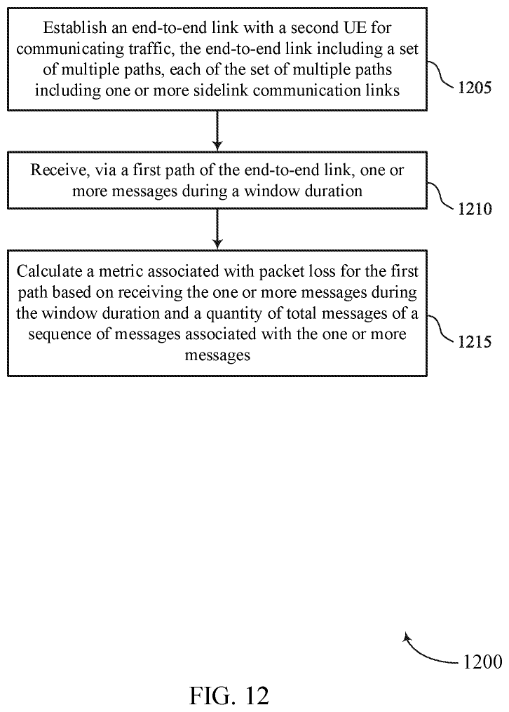

FIG. 12 illustrates a flowchart illustrating a method 1200 that supports measuring performance of E2E communication paths in U2U relay in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include establishing an E2E link with a second UE for communicating traffic, the E2E link including a set of multiple paths, each of the set of multiple paths including one or more sidelink communication links. The operations of 1205 may be performed in accordance with examples as disclosed herein. In some examples, aspects of the operations of 1205 may be performed by a communication path component 925 as described with reference to FIG. 9.

At 1210, the method may include receiving, via a first path of the E2E link, one or more messages during a window duration. The operations of 1210 may be performed in accordance with examples as disclosed herein. In some examples, aspects of the operations of 1210 may be performed by a path measurement component 930 as described with reference to FIG. 9.

At 1215, the method may include calculating a metric associated with packet loss for the first path based on receiving the one or more messages during the window duration and a quantity of total messages of a sequence of messages associated with the one or more messages. The operations of 1215 may be performed in accordance with examples as disclosed herein. In some examples, aspects of the operations of 1215 may be performed by a packet loss component 940 as described with reference to FIG. 9.

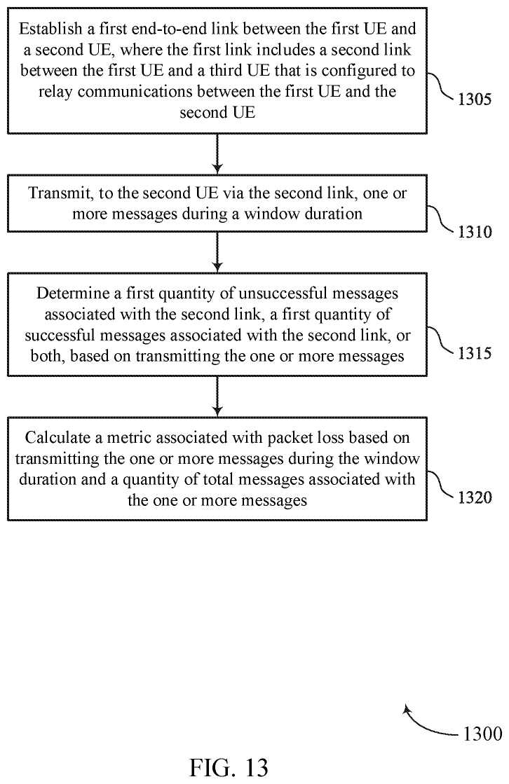

FIG. 13 illustrates a flowchart illustrating a method 1300 that supports measuring performance of E2E communication paths in U2U relay in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include establishing a first E2E link between the first UE and a second UE, where the first link includes a second link between the first UE and a third UE that is configured to relay communications between the first UE and the second UE. The operations of 1305 may be performed in accordance with examples as disclosed herein. In some examples, aspects of the operations of 1305 may be performed by a communication path component 925 as described with reference to FIG. 9.

At 1310, the method may include transmitting, to the second UE via the second link, one or more messages during a window duration. The operations of 1310 may be performed in accordance with examples as disclosed herein. In some examples, aspects of the operations of 1310 may be performed by a path measurement component 930 as described with reference to FIG. 9.

At 1315, the method may include determining a first quantity of unsuccessful messages associated with the second link, a first quantity of successful messages associated with the second link, or both, based on transmitting the one or more messages. The operations of 1315 may be performed in accordance with examples as disclosed herein. In some examples, aspects of the operations of 1315 may be performed by a packet loss component 940 as described with reference to FIG. 9.

At 1320, the method may include calculating a metric associated with packet loss based on transmitting the one or more messages during the window duration and a quantity of total messages associated with the one or more messages. The operations of 1320 may be performed in accordance with examples as disclosed herein. In some examples, aspects of the operations of 1320 may be performed by a packet loss component 940 as described with reference to FIG. 9.

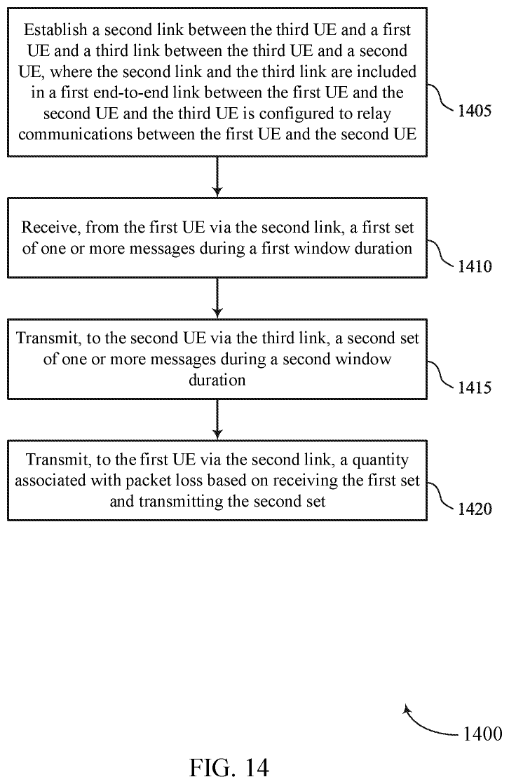

FIG. 14 illustrates a flowchart illustrating a method 1400 that supports measuring performance of E2E communication paths in U2U relay in accordance with one or more aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include establishing a second link between the third UE and a first UE and a third link between the third UE and a second UE, where the second link and the third link are included in a first E2E link between the first UE and the second UE and the third UE is configured to relay communications between the first UE and the second UE. The operations of 1405 may be performed in accordance with examples as disclosed herein. In some examples, aspects of the operations of 1405 may be performed by a communication path component 925 as described with reference to FIG. 9.

At 1410, the method may include receiving, from the first UE via the second link, a first set of one or more messages during a first window duration. The operations of 1410 may be performed in accordance with examples as disclosed herein. In some examples, aspects of the operations of 1410 may be performed by a path measurement component 930 as described with reference to FIG. 9.

At 1415, the method may include transmitting, to the second UE via the third link, a second set of one or more messages during a second window duration. The operations of 1415 may be performed in accordance with examples as disclosed herein. In some examples, aspects of the operations of 1415 may be performed by a path measurement component 930 as described with reference to FIG. 9.

At 1420, the method may include transmitting, to the first UE via the second link, a quantity associated with packet loss based on receiving the first set and transmitting the second set. The operations of 1420 may be performed in accordance with examples as disclosed herein. In some examples, aspects of the operations of 1420 may be performed by a packet loss component 940 as described with reference to FIG. 9.

The following provides an overview of aspects of the present disclosure:

Aspect 1: A method for wireless communication at a first UE, comprising: establishing an E2E link with a second UE for communicating traffic, the E2E link comprising a plurality of paths, each of the plurality of paths comprising one or more sidelink communication links: communicating, with the second UE via a first path of the plurality of paths of the E2E link, a first message associated with measuring a RTT for the first path of the E2E link: communicating a second message via the first path of the E2E link based at least in part on communicating the first message; and calculating the RTT associated with the first path of the E2E link based at least in part on communicating the first message and the second message.

Aspect 2: The method of aspect 1, further comprising: communicating with the second UE based at least in part on calculating the RTT, wherein the first message and the second message are associated with a PDCP layer of a communication protocol stack.

Aspect 3: The method of any of aspects 1 through 2, wherein the first message is a first PDU of a PDCP layer that comprises a first header configured for measuring RTTs, a SDU associated with a RTT request, or both, and the second message is a second PDU of the PDCP layer that comprises a second header configured for measuring RTTs, a SDU associated with a RTT response, or both.

Aspect 4: The method of any of aspects 1 through 3, further comprising: storing a first timestamp associated with transmitting the first message, wherein calculating the RTT associated with the E2E link comprises: calculating a difference between a second timestamp associated with receiving the second message and the first timestamp.

Aspect 5: The method of any of aspects 1 through 4, further comprising: receiving, from a network entity, a message comprising a configuration, wherein the second message is associated with the first message based at least in part on the configuration.

Aspect 6: The method of any of aspects 1 through 5, further comprising: receiving, from a network entity, a message comprising a configuration indicating a window duration associated with communicating the second message, the second message comprising a status report.

Aspect 7: The method of aspect 6, wherein the configuration indicates to transmit a respective status report for one or more round-trip request messages received during the window duration, the respective status report comprising a sequence number, a count value, or both, associated with the one or more round-trip request messages, the one or more round-trip request messages comprises the first message.

Aspect 8: The method of any of aspects 6 through 7, further comprising: calculating a sequence number count based at least in part on an index value, the window duration, and an initial sequence number associated with a first round-trip request message, wherein the status report comprises the sequence number count.

Aspect 9: The method of any of aspects 1 through 8, wherein communicating the second message further comprises: transmitting the second message in a next available transmission time resource subsequent to receiving the first message.

Aspect 10: A method for wireless communication at a first UE, comprising: establishing an E2E link with a second UE for communicating traffic, the E2E link comprising a plurality of paths, each of the plurality of paths comprising one or more sidelink communication links: receiving, via a first path of the E2E link, one or more messages during a window duration; and calculating a metric associated with packet loss for the first path based at least in part on receiving the one or more messages during the window duration and a quantity of total messages of a sequence of messages associated with the one or more messages.

Aspect 11: The method of aspect 10, wherein the one or more messages are associated with a PDCP layer of a communication protocol stack.

Aspect 12: The method of aspect 11, further comprising: transmitting, to the second UE, the calculated metric associated with packet loss via a radio resource control layer of the communication protocol stack, the PDCP layer of the communication protocol stack, or both.

Aspect 13: The method of any of aspects 11 through 12, wherein calculating the metric associated with packet loss further comprises: determining a quantity of unsuccessful messages associated with the one or more messages during the window duration based at least in part on one or more sequence numbers, one or more count values, or both, associated with the one or more messages: calculating the quantity of total messages based at least in part on a combination of the quantity of unsuccessful messages and a quantity of successful messages associated with the one or more messages during the window duration; and calculating the metric based at least in part on a separation between the quantity of unsuccessful messages and the quantity of total messages.

Aspect 14: The method of any of aspects 11 through 13, wherein calculating the metric associated with packet loss further comprises: calculating a respective metric for each radio bearer of a set of radio bearers based at least in part on respective sets of messages for each radio bearer of the set of radio bearers and a respective quantity of total messages for each radio bearer of the set of radio bearers.

Aspect 15: The method of any of aspects 11 through 14, further comprising: reordering the one or more messages based on a respective sequence number for each of the one or more messages, wherein calculating the metric associated with packet loss is further based at least in part on reordering the one or more messages.

Aspect 16: The method of any of aspects 11 through 15, further comprising: receiving, from a network entity, the second UE, or both, a configuration indicating the window duration, wherein calculating the metric associated with packet loss is further based at least in part on the configuration.

Aspect 17: The method of any of aspects 11 through 16, wherein the one or more messages comprise SDUs of the PDCP layer.

Aspect 18: The method of any of aspects 11 through 17, further comprising: transmitting, to the second UE, a plurality of messages associated with packet loss, wherein receiving the one or more messages is based at least in part on transmitting the plurality of messages, the plurality of messages comprising SDUs of the PDCP layer.

Aspect 19: The method of aspect 18, wherein the one or more messages comprise respective status reports configured by a network entity for each SDU of the plurality of messages during a second window duration included in the window duration, each SDU of the plurality of messages during a first periodic window duration comprising the window duration, or each successful SDU of the plurality of messages during a second periodic window duration comprising the window duration, the respective status reports indicating an unsuccessful message or a successful message.

Aspect 20: The method of any of aspects 11 through 19, further comprising: transmitting, to the second UE, a first message indicating to start a path loss measurement procedure based at least in part on establishing the E2E link and a second message indicating to stop the path loss measurement procedure based at least in part on receiving the one or more messages, wherein the window duration is associated with the indication to start and the indication to stop.

Aspect 21: The method of any of aspects 11 through 20, wherein calculating the metric associated with packet loss further comprises: calculating a respective metric associated with each path of the plurality of paths based at least in part on a respective quantity of unsuccessful messages associated with each path and a respective quantity of successful messages associated with each path, the respective quantity of unsuccessful messages, the respective quantity of successful messages, or both, indicated by the one or more messages.

Aspect 22: A method for wireless communication at a first UE, comprising: establishing a first E2E link between the first UE and a second UE, wherein the first link comprises a second link between the first UE and a third UE that is configured to relay communications between the first UE and the second UE; transmitting, to the second UE via the second link, one or more messages during a window duration; determining a first quantity of unsuccessful messages associated with the second link, a first quantity of successful messages associated with the second link, or both, based at least in part on transmitting the one or more messages; and calculating a metric associated with packet loss based at least in part on transmitting the one or more messages during the window duration and a quantity of total messages associated with the one or more messages.

Aspect 23: The method of aspect 22, further comprising: receiving, from the third UE via a radio link control layer, a message indicating a second quantity of unsuccessful messages associated with a third link between the third UE and the second UE, a second quantity of successful messages associated with the third link, or both, wherein determining the first quantity of unsuccessful messages or the first quantity of successful messages is further based at least in part on a threshold associated with retransmission being satisfied.

Aspect 24: The method of aspect 23, wherein calculating the metric further comprises: calculating the metric based at least in part on a combination of the first quantity of unsuccessful messages and the second quantity of unsuccessful messages, wherein the metric is associated with the first link: or calculating the metric based at least in part on a combination of the first quantity of successful messages and the second quantity of successful messages, wherein the metric is associated with the first link.

Aspect 25: The method of any of aspects 22 through 24, wherein determining the first quantity of unsuccessful messages or the first quantity of successful messages is further based at least in part on one or more sequence numbers associated with the one or more messages, the method further comprising: calculating the quantity of total messages based at least in part on a combination of the first quantity of unsuccessful messages and the first quantity of successful messages associated with the one or more messages; and calculating a second metric associated with successfully received messages based at least in part on a separation between the first quantity of successful messages and the quantity of total messages.

Aspect 26: The method of aspect 25, further comprising: receiving, from the second UE, a message indicating a third metric associated with successfully received messages on a third link between the third UE and the second UE, wherein calculating the metric associated with packet loss comprises: calculating a first difference between a first value and the second metric and a second difference between a second value and the third metric; and calculating a third difference between a third value and a product of the first difference and the second difference.

Aspect 27: The method of any of aspects 22 through 26, further comprising: receiving, from the second UE, a message indicating a second metric associated with successfully received messages on the second link and a third metric associated with successfully received messages on a third link between the third UE and the second UE, wherein the second metric comprises the first quantity of successful messages and calculating the metric associated with packet loss comprises: calculating a first difference between a first value and the second metric and a second difference between a second value and the third metric; and calculating a third difference between a third value and a product of the first difference and the second difference.

Aspect 28: The method of any of aspects 22 through 27, wherein the one or more messages are associated with a radio link control layer of a communication protocol stack.

Aspect 29: A method for wireless communication at a third UE, comprising: establishing a second link between the third UE and a first UE and a third link between the third UE and a second UE, wherein the second link and the third link are included in a first E2E link between the first UE and the second UE and the third UE is configured to relay communications between the first UE and the second UE: receiving, from the first UE via the second link, a first set of one or more messages during a first window duration; transmitting, to the second UE via the third link, a second set of one or more messages during a second window duration; and transmitting, to the first UE via the second link, a quantity associated with packet loss based at least in part on receiving the first set and transmitting the second set.

Aspect 30: The method of aspect 29, further comprising: receiving, from the second UE via the third link, a first message indicating a first quantity of successful messages associated with the third link and the second set, a first quantity of unsuccessful messages associated with the third link and the second set, or both; determining a second quantity of successful messages associated with the second link and the first set, a second quantity of unsuccessful messages associated with the second link and the first set, or both, based at least in part on a threshold associated with retransmission being satisfied; and calculating the quantity associated with packet loss based at least in part on a combination between the first quantity of successful messages and the second quantity of successful messages or a combination between the first quantity of unsuccessful messages and the second quantity of unsuccessful messages.

Aspect 31: An apparatus for wireless communication at a first UE, comprising a processor: memory coupled with the processor; and instructions stored in the memory and executable by the processor to cause the apparatus to perform a method of any of aspects 1 through 9.

Aspect 32: An apparatus for wireless communication at a first UE, comprising at least one means for performing a method of any of aspects 1 through 9.

Aspect 33: A non-transitory computer-readable medium storing code for wireless communication at a first UE, the code comprising instructions executable by a processor to perform a method of any of aspects 1 through 9.

Aspect 34: An apparatus for wireless communication at a first UE, comprising a processor: memory coupled with the processor; and instructions stored in the memory and executable by the processor to cause the apparatus to perform a method of any of aspects 10 through 21.

Aspect 35: An apparatus for wireless communication at a first UE, comprising at least one means for performing a method of any of aspects 10 through 21.

Aspect 36: A non-transitory computer-readable medium storing code for wireless communication at a first UE, the code comprising instructions executable by a processor to perform a method of any of aspects 10 through 21.

Aspect 37: An apparatus for wireless communication at a first UE, comprising a processor: memory coupled with the processor; and instructions stored in the memory and executable by the processor to cause the apparatus to perform a method of any of aspects 22 through 28.

Aspect 38: An apparatus for wireless communication at a first UE, comprising at least one means for performing a method of any of aspects 22 through 28.

Aspect 39: A non-transitory computer-readable medium storing code for wireless communication at a first UE, the code comprising instructions executable by a processor to perform a method of any of aspects 22 through 28.

Aspect 40: An apparatus for wireless communication at a third UE, comprising a processor: memory coupled with the processor; and instructions stored in the memory and executable by the processor to cause the apparatus to perform a method of any of aspects 29 through 30.

Aspect 41: An apparatus for wireless communication at a third UE, comprising at least one means for performing a method of any of aspects 29 through 30.

Aspect 42: A non-transitory computer-readable medium storing code for wireless communication at a third UE, the code comprising instructions executable by a processor to perform a method of any of aspects 29 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first user equipment (UE), comprising:
a processor;
memory coupled with the processor; and
instructions stored in the memory and executable by the processor to cause the apparatus to:
establish an end-to-end link with a second UE for communicating traffic, the end-to-end link comprising a plurality of paths, each of the plurality of paths comprising one or more sidelink communication links;
communicating, with the second UE via a first path of the plurality of paths of the end-to-end link, a first message associated with measuring a round-trip time for the first path of the end-to-end link;
communicate a second message via the first path of the end-to-end link based at least in part on communicating the first message; and
calculate the round-trip time associated with the first path of the end-to-end link based at least in part on communicating the first message and the second message.

2. The apparatus of claim 1, wherein the instructions are further executable by the processor to cause the apparatus to:
communicate with the second UE based at least in part on calculating the round-trip time, wherein the first message and the second message are associated with a packet data convergence protocol layer of a communication protocol stack.

3. The apparatus of claim 1, wherein:
the first message is a first protocol data unit of a packet data convergence protocol layer that comprises a first header configured for measuring round-trip times, a service data unit associated with a round-trip time request, or both; and
the second message is a second protocol data unit of the packet data convergence protocol layer that comprises a second header configured for measuring round-trip times, a service data unit associated with a round-trip time response, or both.

4. The apparatus of claim 1, wherein the instructions are further executable by the processor to cause the apparatus to:
store a first timestamp associated with transmitting the first message, wherein to calculate the round-trip time associated with the end-to-end link, wherein the instructions to calculate the round-trip time are executable by the processor to cause the apparatus to:
calculate a difference between a second timestamp associated with receiving the second message and the first timestamp.

5. The apparatus of claim 1, wherein the instructions are further executable by the processor to cause the apparatus to:
receive, from a network entity, a message comprising a configuration, wherein the second message is associated with the first message based at least in part on the configuration.

6. The apparatus of claim 1, wherein the instructions are further executable by the processor to cause the apparatus to:
receive, from a network entity, a message comprising a configuration indicating a window duration associated with communicating the second message, the second message comprising a status report.

7. The apparatus of claim 6, wherein the configuration indicates to transmit a respective status report for one or more round-trip request messages received during the window duration, the respective status report comprising a sequence number, a count value, or both, associated with the one or more round-trip request messages, wherein the one or more round-trip request messages comprises the first message.

8. The apparatus of claim 6, wherein the instructions are further executable by the processor to cause the apparatus to:
calculate a sequence number count based at least in part on an index value, the window duration, and an initial sequence number associated with a first round-trip request message, wherein the status report comprises the sequence number count.

9. The apparatus of claim 1, wherein the instructions to communicate the second message are further executable by the processor to cause the apparatus to:
transmit the second message in a next available transmission time resource subsequent to receiving the first message.

10. An apparatus for wireless communication at a first user equipment (UE), comprising:
a processor;
memory coupled with the processor; and
instructions stored in the memory and executable by the processor to cause the apparatus to:
establish an end-to-end link with a second UE for communicating traffic, the end-to-end link comprising a plurality of paths, each of the plurality of paths comprising one or more sidelink communication links;
receive, via a first path of the end-to-end link, one or more messages during a window duration; and
calculate a metric associated with packet loss for the first path based at least in part on receiving the one or more messages during the window duration and a quantity of total messages of a sequence of messages associated with the one or more messages.

11. The apparatus of claim 10, wherein the one or more messages are associated with a packet data convergence protocol layer of a communication protocol stack.

12. The apparatus of claim 11, wherein the instructions are further executable by the processor to cause the apparatus to:
transmit, to the second UE, the calculated metric associated with packet loss via a radio resource control layer of the communication protocol stack, the packet data convergence protocol layer of the communication protocol stack, or both.

13. The apparatus of claim 11, wherein the instructions to calculate the metric associated with packet loss are further executable by the processor to cause the apparatus to:
determine a quantity of unsuccessful messages associated with the one or more messages during the window duration based at least in part on one or more sequence numbers, one or more count values, or both, associated with the one or more messages;
calculate the quantity of total messages based at least in part on a combination of the quantity of unsuccessful messages and a quantity of successful messages associated with the one or more messages during the window duration; and
calculate the metric based at least in part on a separation between the quantity of unsuccessful messages and the quantity of total messages.

14. The apparatus of claim 11, wherein the instructions to calculate the metric associated with packet loss are further executable by the processor to cause the apparatus to:
calculate a respective metric for each radio bearer of a set of radio bearers based at least in part on respective sets of messages for each radio bearer of the set of radio bearers and a respective quantity of total messages for each radio bearer of the set of radio bearers.

15. The apparatus of claim 11, wherein the instructions are further executable by the processor to cause the apparatus to:
reorder the one or more messages based on a respective sequence number for each of the one or more messages, wherein calculating the metric associated with packet loss is further based at least in part on reordering the one or more messages.

16. The apparatus of claim 11, wherein the instructions are further executable by the processor to cause the apparatus to:
receive, from a network entity, the second UE, or both, a configuration indicating the window duration, wherein calculating the metric associated with packet loss is further based at least in part on the configuration.

17. (canceled)

18. The apparatus of claim 11, wherein the instructions are further executable by the processor to cause the apparatus to:
transmit, to the second UE, a plurality of messages associated with packet loss, wherein receiving the one or more messages is based at least in part on transmitting the plurality of messages, the plurality of messages comprising service data units of the packet data convergence protocol layer.

19. (canceled)

20. The apparatus of claim 11, wherein the instructions are further executable by the processor to cause the apparatus to:
transmit, to the second UE, a first message indicating to start a path loss measurement procedure based at least in part on establishing the end-to-end link and a second message indicating to stop the path loss measurement procedure based at least in part on receiving the one or more messages, wherein the window duration is associated with the indication to start and the indication to stop.

21. The apparatus of claim 11, wherein the instructions to calculate the metric associated with packet loss are further executable by the processor to cause the apparatus to:
calculate a respective metric associated with each path of the plurality of paths based at least in part on a respective quantity of unsuccessful messages associated with each path and a respective quantity of successful messages associated with each path, the respective quantity of unsuccessful messages, the respective quantity of successful messages, or both, indicated by the one or more messages.

22. An apparatus for wireless communication at a first user equipment (UE), comprising:
a processor;
memory coupled with the processor; and
instructions stored in the memory and executable by the processor to cause the apparatus to:
establish a first end-to-end link between the first UE and a second UE, wherein the first link comprises a second link between the first UE and a third UE that is configured to relay communications between the first UE and the second UE;
transmit, to the second UE via the second link, one or more messages during a window duration;
determine a first quantity of unsuccessful messages associated with the second link, a first quantity of successful messages associated with the second link, or both, based at least in part on transmitting the one or more messages; and
calculate a metric associated with packet loss based at least in part on transmitting the one or more messages during the window duration and a quantity of total messages associated with the one or more messages.

23-30. (canceled)
